(19) United States
(12) Patent Application Publication
(10) Pub. No.: US 2015/0254861 A1
(43) Pub. Date: Sep. 10, 2015

(54) APPARATUS AND METHOD FOR DETERMINING SPATIAL INFORMATION ABOUT ENVIRONMENT

(71) Applicant: T. Eric CHORNENKY, (US)

(72) Inventor: T. Eric Chornenky, Carmichaels, PA (US)

(21) Appl. No.: 14/436,991

(22) PCT Filed: Oct. 18, 2013
(86) PCT No.: PCT/US2013/065628

§ 371 Date: Apr. 20, 2015

Related U.S. Application Data
(60) Provisional application No. 61/715,391, filed on Oct. 18, 2012.

(51) Int. Cl. G06T 7/00; H04M 1/21; H04M 1/02

(52) U.S. Cl. CPC G06T 7/0057; H04M 1/0264; H04M 1/21

(57) ABSTRACT

An apparatus includes a first device including light sources that are configured to project one or more references onto a surface. There is a second device including a camera that is configured to capture an image of the one or more projected references and is further configured to capture an image of at least a portion of the surface and/or an object disposed thereon or therewithin. A processing unit is operatively coupled to at least one of the first and second devices and configured to receive and process all images so as to determine an information about the at least portion of the surface and/or the object or objects disposed at least one of on, within and adjacent the surface.

### CROSS-REFERENCE TO RELATED APPLICATIONS

This application is related to and claims priority from U.S. Provisional Patent Application Ser. No. 61/715,391 filed on Oct. 18, 2012 and titled “Laser Enhanced Smart Phone”.

### FIELD OF THE INVENTION

The instant invention is related in general to an apparatus and method for determining spatial relationship, size and orientation of objects or surfaces in an environment. Specifically, the instant invention is directed to a portable apparatus with at least one light emitting device, one camera and a sensor adapted to sensing and recording the dimensions of a room and the position, size and shape of all objects in a room. The invention further relates to a non-contact optical dimensional measuring devices and more specifically to measuring devices which generate dimensional information about building surfaces or objects incorporated into or onto such surfaces.

### STATEMENT REGARDING FEDERALLY SPONSORED RESEARCH AND DEVELOPMENT

N/A

### REFERENCE TO SEQUENCE LISTING, A TABLE, OR A COMPUTER PROGRAM LISTING COMPACT DISC APPENDIX

N/A

### BACKGROUND OF THE INVENTION

As is generally well known, 3-D images are obtained by scanning an object using a scanning laser which progressively illuminates the surface of the desired object through a vertical and horizontal motion of a laser beam across its surface. A camera is used to triangulate the reflections from the laser off the surface with the camera location and laser scan origination angle to determine the complete profile of the surface of the object. It is further known in the prior art to similarly scan the interior surface of an entire room with a 360 degree vertical rotating laser and horizontal motion of a time-of-flight laser to obtain the room's dimensional measurements and the dimensional measurements of the surface of objects in the room illuminated by the apparatus. It is also commonly known to take dimensional measurements of a room or wall features using a measuring tape or ruler manually.

The above methods are time consuming, requiring a complex mechanical scanning apparatus and/or a significant amount of time to complete operation. Further, the above typically restrict occupants' movement or interfere with normal operational usage by the rooms occupants while measurements are being taken. Further, the above methods are costly in man hours or equipment investment, reducing the overall occurrences of generating such dimensional data. Also, the desired end result of CAD drawings of the room features therein are not easily and automatically derived from the raw data gathered, the numerical representations being colorless abstractions only, and often containing data referencing features of no interest. Finally, the above methods require a significant amount of human preparation or intervention.

Another conventional method employed in measuring distances with a light emitting device or laser is a Time-of-Flight (TOF) technique that uses a continuous stream of laser pulses to time the transmission and reflection back of each pulse and calculate the distance based on the speed of light. However, this is more expensive than a simple laser, requiring high-speed electronic circuitry to time events faster than 1 nanosecond, as the speed of light is about 1 ns/ft. Furthermore, typical commercial TOF devices only measure to an accuracy of ⅛ inch, but can do so at significant distances, 10-100 ft. Their accuracy does not change at the shortest or longest distances usable.

Therefore, there is a need for an improved apparatus and method that can generate information about a surface or object in cost and time efficient manners.

### SUMMARY OF THE INVENTION

The invention provides an apparatus for determining spatial relation between and orientation of objects or surfaces in an environment. The apparatus includes a first device configured to project one or more references onto a surface. There is also a second device being configured to capture an image of the one or more projected references and is further configured to capture an image of at least a portion of the surface and/or an object disposed thereon or therewithin. A processing unit is also provided and is configured to receive and process all images so as determine at least one of a distance to, orientation of, a shape of and a size of at least the portion of the surface and/or the object disposed on or within the surface.

The invention also provides a method based on that the physical degrees (angles on x-pixel-axis, Y-pixel-axis and combined-xy-hypotenuse-pixels) (of the desired pixel location) between the camera's′ physical lens center ray (which runs along camera center borescope line or ray from the image plane center) and a pixel seen in the imager on the physical point of interest are calculated based on the camera's hardware angles (picture width degrees and imager number of pixels wide, or picture height degrees and imager number of pixels high), and also based on the pixel locations of/on objects of interest seen in the camera's imager.

The ray's' angles and the known physical distance (x and y) from the lens center to the laser(s), and knowing the angles the lasers are relative to the camera image plane provide the necessary information (a length and 2 angles) to calculate the distance and location of the laser point formed when reflecting off a wall surface and back into the camera's lens and onto the camera's imager pixel array, relative to the camera's lens center as spatial location (0,0,0) and the orientation of the camera's imager pixel plane.

In accordance with one embodiment, the apparatus includes one light source in combination with a smart phone, wherein the multiple references are projected by a method of rotating the smart phone.

In accordance with another embodiment, the apparatus includes two light sources in combination with a smart phone wherein additional reference are projected by a method of rotating the smart phone.

In accordance with a further embodiment, the apparatus includes three light sources in combination with a smart phone wherein the fourth reference is pseudo projected by a logic algorithm.

In accordance with yet a further embodiment, the apparatus includes four light sources in combination with a smart phone.

In accordance with another embodiment, the apparatus includes four light sources mounted on a handheld device with a universal joint maintaining generally vertical planes of each light source and wherein the camera is positioned for independent movement and/or rotation.

In accordance with a further embodiment, the apparatus includes four light sources mounted on a handheld device with a three-axis accelerometer and wherein the camera is positioned for independent movement and/or rotation.

In accordance with yet another embodiment, the apparatus includes four light sources mounted on a handheld device with a universal joint maintaining generally vertical planes of each light source and wherein the camera is positioned within the orthogonal confines defined by, four light sources.

In accordance with a further embodiment, the apparatus includes a generally cube shape with light source and a camera provided on each side.

In accordance with yet further embodiment, the apparatus includes a member configured for flying in a plane generally parallel to a ground plane and wherein a camera and a light source are mounted on each surface of such member.

### OBJECTS OF THE INVENTION

It is, therefore, one of the primary objects of the present invention to provide a portable, single-hand held apparatus using inexpensive laser components, inexpensive camera and inexpensive orientation creating and/or sensing devices to quickly determine the distances to, distances between, orientation between, dimensions of, area of, or orientation of objects or features on a flat surface.

Another object of the present invention is to provide an accurate Local Positioning System to precisely determine, locate or recreate the position of the apparatus inside or alongside a room or building structure, including optionally determining or recreating the orientation of the apparatus.

Yet another object of the present invention is to provide an apparatus to facilitate or automatically acquire images for semi or fully automatic generation of CAD output from images containing its temporary artificially created reference features.

A further object of the present invention is to provide an apparatus to automatically navigate to and recreate its position and orientation in a room or building to then verify animate or inanimate objects have not been spatially modified, moved or removed especially for security purposes

Yet a further object of the present invention is to provide an inexpensive apparatus to measure dimensions of or distance to objects or reference points on a surface with more accuracy than a time-of-flight laser measuring means in a noncontact manner.

An additional object of the present invention is to provide an apparatus which can measure the dimensions of an object and easily allow designation of the desired object from any angle by the user, at the instant of use by, for example, easily centering the chosen object in a visible reference scene.

Another object of the present invention is to provide an inexpensive retrofittable or removeably attachable apparatus to an existing Smartphone, computer tablet or camera which enables semi-automatic CAD generation.

Another object of the present invention is to provide an apparatus to enable semi-automated CAD generation inexpensively using any form of camera, hence not requiring the user to purchase a camera but use their existing one.

Another object of the present invention is to provide a real time CAD projection capability based on the dimensions acquired and an associated laser scanning projector.

A further object of the present invention is to provide an apparatus to instantly measure the exact dimensions of an average room, even one whose walls are mostly obstructed by furniture such as desks and shelving.

In addition to the several objects and advantages of the present invention which have been described with some degree of specificity above, various other objects and advantages of the invention will become more readily apparent to those persons who are skilled in the relevant art, particularly, when such description is taken in conjunction with the attached drawing Figures and with the appended claims.

### BRIEF DESCRIPTION OF THE DRAWINGS

FIG. 1 is a front planar elevation view of a handheld apparatus of the invention;

FIG. 2 is a side elevation view of the apparatus of FIG. 1, also illustrating an elongated handle;

FIG. 3 is one block diagram of the apparatus of FIG. 1;

FIG. 4 is another block diagram of the apparatus of FIG. 1;

FIG. 5 is a rear elevation view of the apparatus of the invention illustrated in combination with a smart phone;

FIG. 6 is a front elevation view of the apparatus of FIG. 5;

FIG. 7 is a rear elevation view of the apparatus of the invention illustrated for use as an attachment to a smart phone;

FIG. 8 is a cross-sectional elevation view of the apparatus of FIG. 5 along lines VIII-VIII;

FIG. 9 is a flowchart of a method employed in using the apparatus of FIGS. 1-8;

FIG. 10 illustrates a diagram of an reference image projected onto the wall from the first device employing three light emitting devices, wherein the light beams are parallel with each other, with the camera positioned remotely form the first device;

FIG. 11 illustrates a maximum angle of the camera pixel grid in a horizontal plane with the lower vertex representing the camera lens center and the upper vertices representing the outer edges of the image along the X-axis;

FIG. 12 illustrates a top-view of the camera pixel imager grid and camera angle relationships when looking down on X-axis;

FIG. 13 illustrates produced image;

FIG. 14 illustrates a model to calculate hypotenuse physical 3d angle to the pixel laser point from the camera lens center;

FIG. 15 illustrates a model to calculate physical distances between light emitting devices from the location of the camera lens center;

FIG. 16 illustrates a model to calculate physical distances from light emitting devices to projected references on the surface;

FIG. 17 is a flowchart of a method employing a single light source without use of a line reference;

FIG. 18 illustrates an apparatus having six sides with light emitting device and a camera in or on each side; and

FIG. 19 illustrates an apparatus configured for flying in a plane generally parallel to a ground plane having six sides with light emitting device and a camera in or on each side.

### BRIEF DESCRIPTION OF THE VARIOUS

### Embodiments of the Invention

Prior to proceeding to the more detailed description of the present invention, it should be noted that, for the sake of clarity and understanding, identical components which have identical functions have been identified with identical reference numerals throughout the several views illustrated in the drawing figures.

It is to be understood that the definition of a laser applies to a device that produces a narrow and powerful beam of light. It is to be understood that that the definition of an accelerometer applies to a device that measures non-gravitational accelerations and, more specifically, an inertial sensor that measures inclination, tilt, or orientation in 2 or 3 dimensions, as referenced from the acceleration of gravity (1 g=9.8 m/s²). By way of one example, Apple iPhone includes a 3-way axis device which is used to determine the iPhone's physical position. The accelerometer can determine when the iPhone is tilted, rotated, or moved.

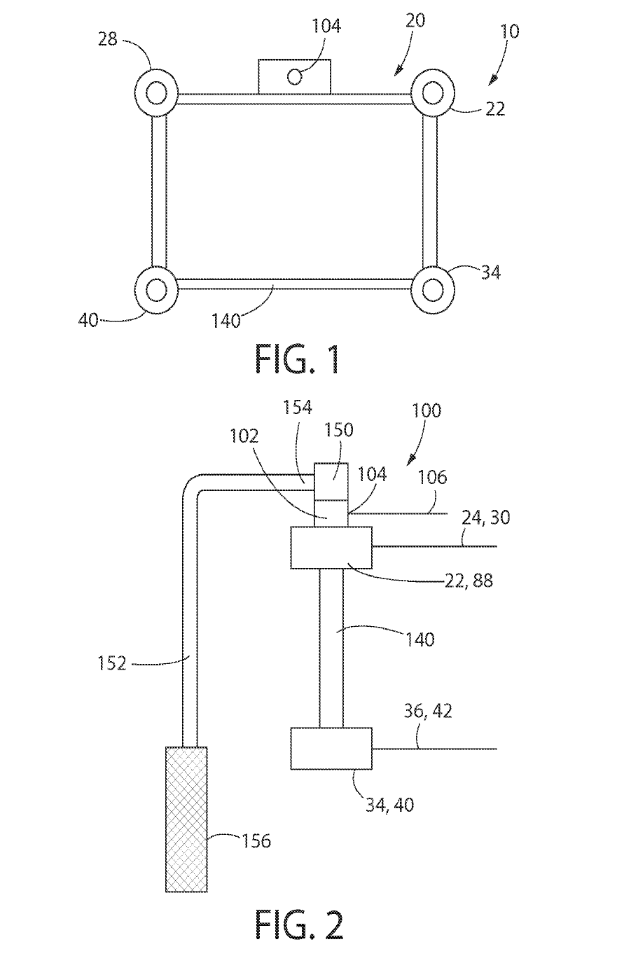

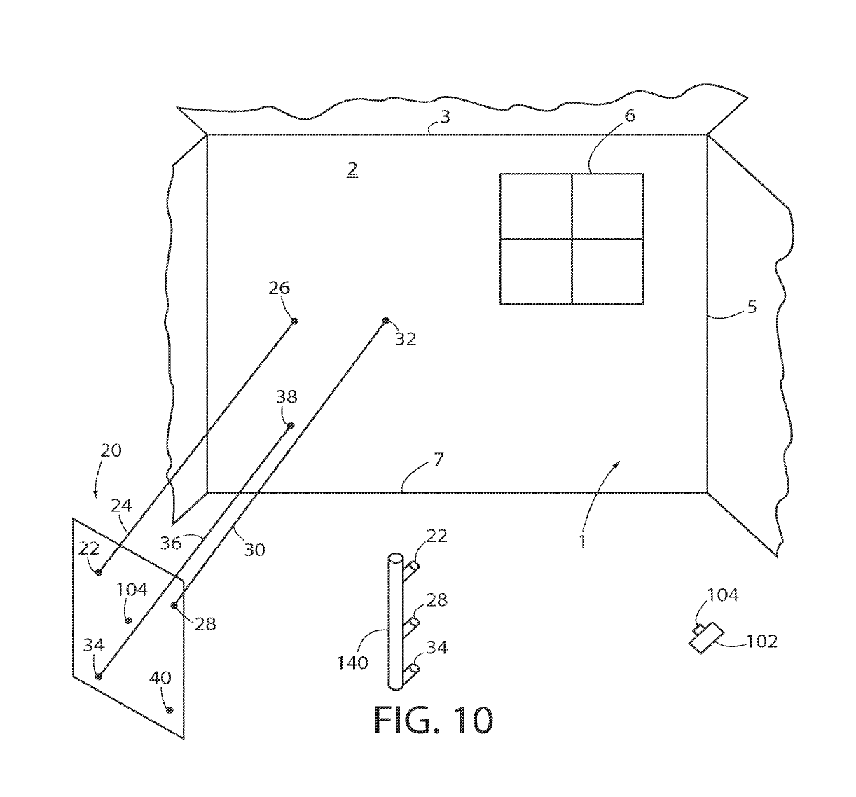

Reference is now made, to FIGS. 1-4 and 10, wherein there is shown an apparatus, generally designated as 10. The apparatus 10 includes a first device, generally designated as 20, configured to project one or more references 22 onto a surface 2, which is preferably is disposed vertically. The first device 20 includes at least one light source 22 and may further include a second light source 28, a third light source 34 and a fourth light source 40. Each light source is preferably a conventional laser configured to emit a beam of light having an axis and projecting a reference onto the surface 2. The reference may appear as a point being a conventional dot, ellipse or circle, although other shapes are also contemplated herewithin. For the sake of reader convenience, the light source 22 defines the axis 24 and reference 26; the second light source 28 defines axis 30 and reference 32; the third light source 34 defines axis 36 and reference 38; and the fourth light source 40 defines axis 42 and reference 44. In further reference to FIGS. 1-2, such apparatus 10 is illustrated as including four light sources, each disposed at a corner of an orthogonal pattern and operable to emit a beam of light. For the reasons to be explained later, preferably axis of the four light sources are disposed in a parallel relationships with each other and wherein the first device 20 projects four references disposed in an orthogonal pattern on the surface 2. The axes of such four light sources are either parallel to a ground surface or disposed at an inclined thereto.

Alternatively, each light source may be provided as a light emitting diode (LED) or an infrared emitter.

The apparatus 10 further includes a second device, generally designated as 100, which is configured to capture an image of the one or more projected references 26, 32, 38 and 44 and is further configured to capture an image of at least a portion of the surface 2 and any object 6 disposed thereon or therewithin. The object can be any one of a location such as a point on the surface 2 being closest to the second device 100, a feature, such as a window, picture, or a line for example representing a juncture between a wall and a ceiling in a room of a dwelling. In the instant invention the second device 100 is a camera 102 having a lens 104 and an axis 106. The camera 102 may be of any conventional type and is preferably of the type as employed in mobile communication devices, such as mobile phone, tablets, pads and the like devices.

Another essential embodiment of the apparatus 10 is a processing unit 120, which is operatively coupled to at least one of the first and second devices, 20 and 100 respectively, and which is configured to receive and process all images so as determine at least one of a distance to, a shape of and a size of at least the portion of the surface 2 and/or the object disposed on within the surface 2. Conventionally, the processing unit 120 includes at least a processor 122, such as microprocessor and memory 124 mounted onto a printed circuit board (PCB) 126.

The processor 122 is configured to triangulate angular relationships between an axis of the second device 100 and each of the projected references 26, 32, 38 and 44 in accordance with a predetermined logic and is further configured to determine the size of the at least the portion of the surface 2 and/or the object 6 disposed thereon or therewithin.

Yet another essential embodiment of the apparatus 10 is a power source 130 configured to source power to first device 10, second device 100 and the processing unit 120. The power source is of any conventional battery type either rechargeable or replaceable.

In further reference to FIGS. 1-2, the first device 10, second device 100 and the processing unit 120 may be mounted onto a mounting member, generally designated as 140. The shape and construction of the mounting member 140 varies in accordance with the embodiments described below but is essentially sufficient to mechanically attach such first device 10, second device 100, the processing unit 120 and the power source 130 thereonto and provide means for operative coupling, by way of electrical connections, between the first device 10, second device 100, the processing unit 120 and the power source 130 either internal or external to the surfaces of the mounting member 140.

It has been found essential to maintain axis 24, 30, 36, and 42 generally parallel, except for a small angular tolerance deviations) to a horizontal axis during use of the apparatus 10 employing four light sources. Accordingly, in these configurations, the apparatus 10 includes a joint 150 configured to maintain, due to freedom of rotation, such axial orientation. Preferably, the joint 150 is of a conventional U-joint type. The apparatus 10, may further include a handle 152 having one end 154 thereof connected to the U-joint 150 and having an opposite end 156 thereof configured to be held within a hand of a user of the apparatus 10. In other words, the U-joint 150 movably connects the mounting member 140 to the end 154 of the handle member 152, wherein the U-joint 150 is configured to at least align axis of the first device 20 with a horizontal orthogonal axis during use of the apparatus 10.

In another form, the first device 20 includes two or three light sources 22, 28 and 34, spaced from each other in at least one of vertical and horizontal directions during use of the apparatus 10, each operable to emit a beam of light and wherein the first device 20 further includes a sensor 160 configured to measure an angular displacement of an axis of each light source 22, 28 and 34 from an orthogonal horizontal axis. In the instant invention, the sensor 160 is one of an inclinometer, an accelerometer, a magnetic compass, a gyroscope.

In yet another form, the first device 20 includes a single light source 22 operable to emit the beam of light 24 defining the one reference 26 and is further operable by, a rotation, to project two or more successive references 32, 38 and 44 and wherein the first device 20 further includes the sensor 160 configured to measure an angular displacement of an axis of the single light source 22 and/or an axis of the second device 100 from one or more orthogonal axis.

Alternatively, the first device 20 includes a single light source 22 operable to emit a beam of light 24 defining the one reference 26, wherein the first device 20 further includes a sensor 160 configured to measure an angular displacement of an axis of the beam of light 24 and/or an axis of the second device 100 from one or more orthogonal axis and wherein the second device 100 is operable to capture an image of a horizontal reference line, for example such as wall-to-ceiling line 3.

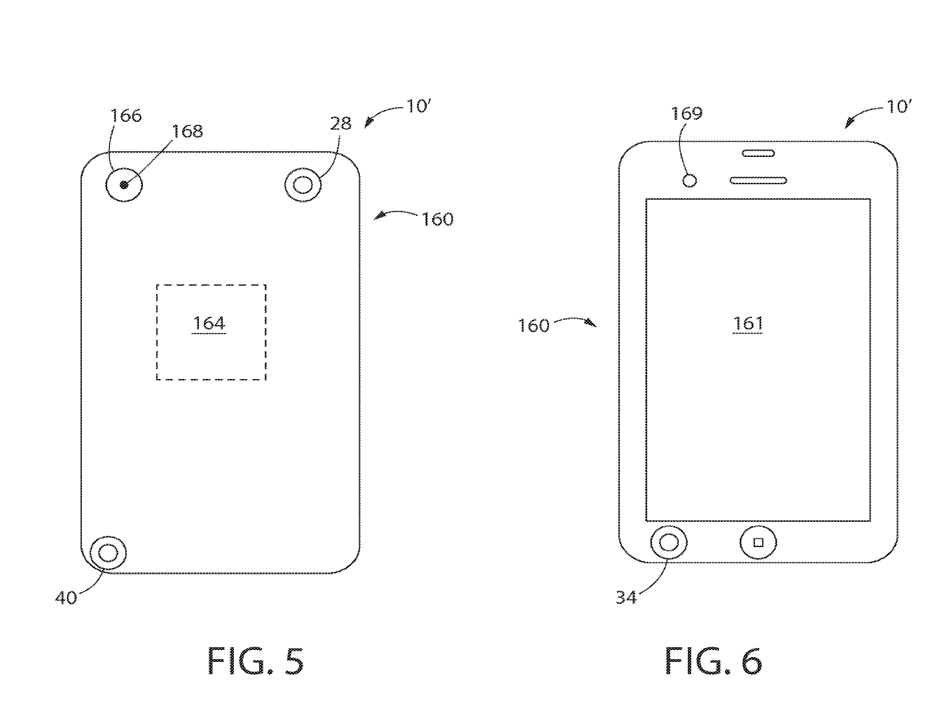

Now in reference to FIGS. 5-6, therein is illustrated another embodiment, wherein the apparatus 10′ further comprises a mobile communication device 160, wherein the first device 20 is directly attached to or being integral with a housing 162 of the mobile communication device 160, wherein the processing unit 120 is integrated into a processing unit 164 of the mobile communication device 160 and wherein the camera 102 of the second device 100 is a camera 166 provided within the mobile communication device 160, the camera 166 having a lens 168.

More specifically, FIG. 5 illustrates a pair of light sources 22 and 40 facing from the rear surface of the housing 162 so that their axis are oriented in the same direction as axis of the lens 168. It is preferred that the pair of light sources 22 and 40 are disposed at opposite diagonal corners of the mobile communication device 160, wherein one light source, referenced with numeral 22, is positioned away from the camera 166.

FIG. 6 illustrates an optional form of the apparatus 10′ employing a third light source 34 having axis 36 thereof oriented in a direction of a front facing camera 169.

The advantage of front and back lasers and cameras in a smart phone device is more than simply taking two scenes simultaneously. Because of the fixed angular and distance relationships between the smart phone's lasers and cameras, as the camera is moved along its axes and directions in the front, it is also moved simultaneously in exactly opposite angular motions and directions in the back.

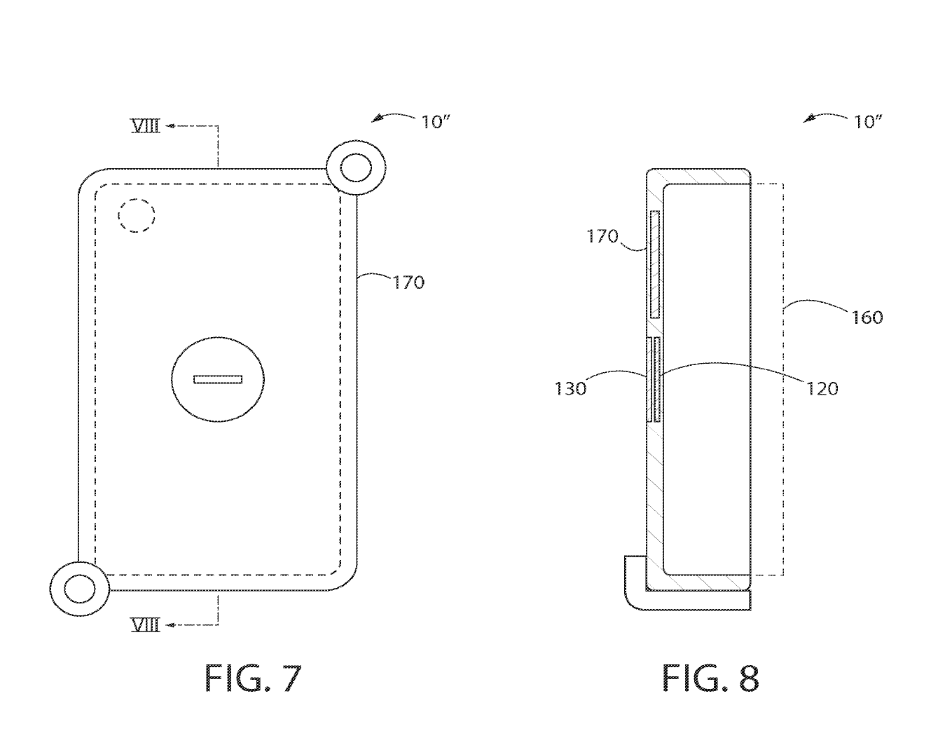

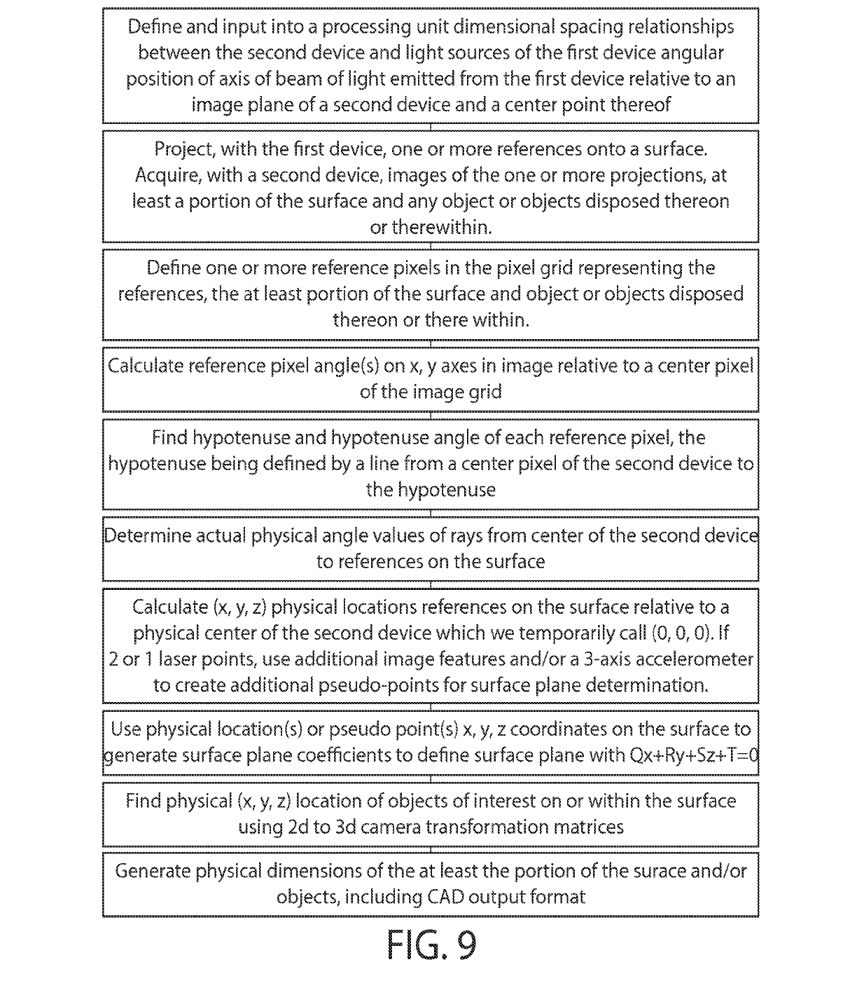

FIGS. 7-8 illustrate yet another embodiment of the instant invention, wherein the apparatus 10″ includes a hollow mounting member 170 configured to releaseably connect, for example by a conventional snapping action, onto an exterior surface of the housing 162 of the mobile communication device 160 and wherein the pair of light sources 22 and 28 are so positioned that their axis are facing in a direction of a rear camera 166 of the mobile communication device 160. The processing unit 120 and the power source 130 are integrated into the thickness of the mounting member 170, with the power source 130 being disposed behind a removable cover 172, although they can be integrated directly into the mobile communication device 160, thus reducing the cost of the apparatus 10″.

In either embodiment, there is provided a switch 180, electrically coupled between the source of power 130 and the first device 20 and manually operable to selectively connect power to and remove the power from the first device 20. The switch 180 can be of a mechanical type, for example of a pushbutton or a slider, can be provided by an icon on a touch screen 161 of the mobile communication device 160, or may be of any other suitable type so that first device 20 is operable from a control signal from the mobile communication device 160.

As it will be explained later, the second device 100 may be disposed external to and remotely from the mounting member 140, 170 during use of the apparatus 10.

The instant invention contemplates in one embodiment that in either apparatus 10, 10′ or 10″, configured with a single light emitting device 22, the processor 122 is configured to determine the information in absence of a time-of-flight light interrogation techniques widely employed with laser based measuring tapes. However, when apparatus 10, 10′ or 10″ includes two or more light emitting devices, it is contemplated that the projected reference from at least one of such two or more light emitting devices is processed/used either in absence of a time-of-flight light laser beam interrogation techniques or the time-of-flight laser beam interrogation techniques are used for some but not all projected references. It has been found that light emitting devices employed with time-of-flight laser beam interrogation techniques are associated with higher than desirable costs and do not provide desired degree of accuracy in applications when the lasers are spaced from the projecting surface and/or object less than about two meters and, more particularly, less than one meter.

The instant invention contemplates in another embodiment that either apparatus 10, 10′ or 10″ is configured as a handheld apparatus employing two or more light emitting devices and is further configured to determine the information without a continuous rotation of the apparatus about any one of three orthogonal axis, while being held by a user tasked to determine the information.

The hand held two laser, three laser or four laser embodiments may also have a mechanism to allow the lasers to be parallel but tilted upward or downward at an angle. This angle is then inputted into the equations and basically determines the laser point spacing parameters.

In the two laser embodiment, one must avoid taking pictures at a non-standard diagonal angle (camera not held vertically or horizontally) where the lasers are inline on a line perpendicular to the ground plane. This would eliminate wall perspective measurement capability. The configuration to achieve maximum laser-laser separation distance on camera, and allowing for some perspective data to be taken if the camera is held perfectly horizontal or vertically and reducing the number of lasers to two, the optimal arrangement is to have the camera 102 in one corner and the two lasers, for examples, 22 and 34, in the corners not diagonal to the camera.

This configuration is optimal because it provides wall perspective data if the camera is held horizontally or vertically while providing near-maximum camera-laser distance separation and maximum laser-laser distance separation. It offers the best usefulness trade offs.

In the one laser embodiment, the laser is best located on the diagonal corner opposite the camera, displaced in distance from the camera the maximum amount and also displaced on both x and y axes.

A very conceptually simple means of using the Smartphone's accelerometer with one laser or two laser embodiments to create/ensure an accurate or more accurate measurement is.

Next, using x, y, z coordinates of the physical location(s) of the projected references or pseudo point(s) on the surface 2 to generate surface plane coefficients to define surface plane with an equation

Qx+Ry+Sz+T=0

wherein,

Q is a coefficient for X-axis

R is a coefficient for Y-axis

S is a coefficient for Z-axis

T is a constant

Calculations to determine Q, R, S, and T are shown below in this document.

The method further includes the step of finding pixels of points on objects of interest on the surface 2 in the captured image and generating additional rays of calculated angles from physical center of the second device 120 to intersect with surface plane at such points. Then, finding physical (x, y, z) locations of object or objects 6 of interest on or within the surface 2 using 2d to 3d camera transformation matrices. Finally, generating physical dimensions of the at least the portion of the surface 2 and/or object or objects 6, including CAD output format.

The logic algorithm is illustrated in combination with three references 26, 32, and 38 projected onto the surface 2 by lasers 22, 28 and 34 respectively, for example such as the above described wall of a room in a dwelling structure. The method is further described based on integration of the first device 20 and the second device 100 within a single mounting member, with the camera 102 being either inside or outside of the pattern boundaries formed by physical locations of light sources or lasers 22, 28 and 34. The sensor 160, when employed, is also integrated into the single mounting member.

For the sake of reader's convenience, the described algorithm employs the following identifier conventions:

A=angle

ACCEL=accelerometer

C=camera

D=distance

L=left

H=hypotenuse

0=image center point

P=pixel

R=right

X=x-axis, horizontal

Y=y-axis, vertical

Z=z-axis, plane into the wall

“in” refers to input, i.e. given data that the user

inputs before room dimensions can be calculated

Reference numeral 22 defines an upper left laser A

Reference numeral 28 defines an upper right laser B

Reference numeral 34 defines a lower left laser C

The projected references 26, 32 and 38 may appear closer together or further apart depending on the distance of the first device 20 from the wall 2.

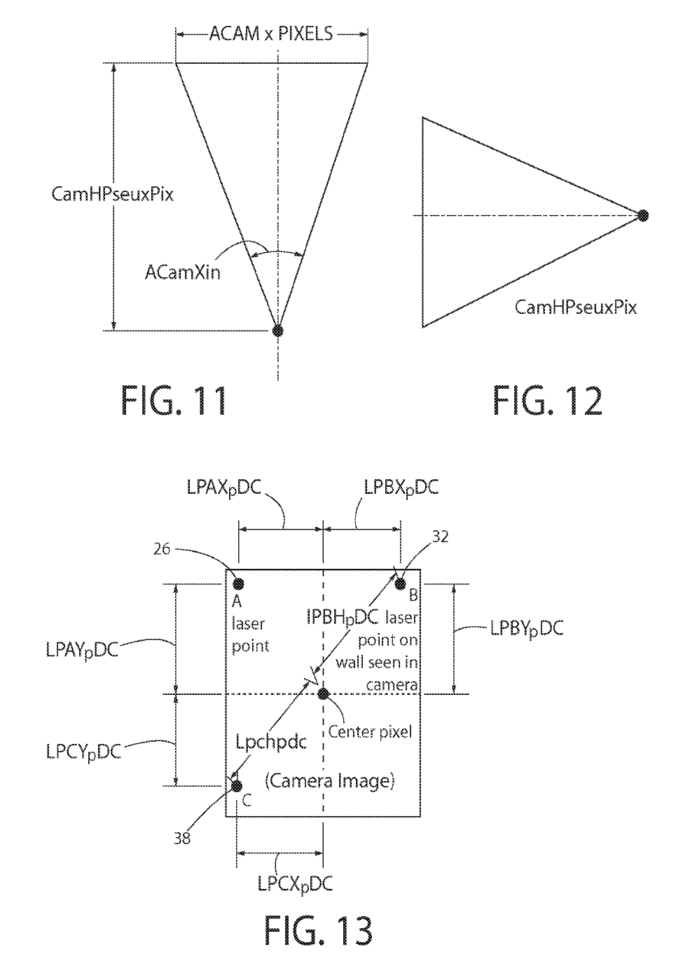

Table contains parameters for spatial dimensions of and between camera 102 and lasers of the first device 20 and pixel grid definitions of the camera lens 104, with the pixel grid defined by the dimensions ACAMxPIXELS and ACAMyPIXELS, with the horizontal pixel distribution shown in FIG. 11. The resulting CamHPseuxPix, also shown further in FIG. 12, is an imaginary construct only to be used so as to more easily calculate the angles of the rays originating from the camera lens center 104 through the imagers pixels to the feature on the wall 2.

TABLE 1
Spatial dimensions between camera 102 and lasers of
the first device 20 and pixel grid definitions of the camera
lens 104

| Parameter | Meaning |
|---|---|
| DLXᵢₙ | X physical distance between lasers 22 and 28 |
| DLYᵢₙ | Y physical distance between lasers 22 and 34 |
| DCLXₐᵢₙ | X physical distance between camera lens center |
| | 104 and lasers 22 and 34. (NOTE: This is negative |
| | but entered as a positive number but is a |
| | negative value on X axis) |
| DCLYₐᵢₙ | Y physical distance between camera lens center |
| | 104 and laser 34 (NOTE: This is negative but |
| | entered as a positive number but is a negative |
| | value on Y axis) |
| DCLX_{b} | X physical distance between camera lens center |
| | 104 and laser 28 |
| DCLY_{b} | Y physical distance between camera lens center |
| | 104 and laser 28 |
| ACAMxPIXELS | Number of pixels of the camera 102 across the |
| | horizontal X axis (x-axis pixel resolution) |
| ACAMyPIXELS | Number of pixels of the camera 102 accross the |
| | vertical Y axis (y-axis pixel resolution) |
| AcamXin | Angle between outermost image limits from camera |
| | 102 in a X-axis across ACAMxPIXELS |
| AcamYin | Angle between outermost image limits from camera |
| | 102 in a Y-axis across ACAMyPIXELS |

Preferably, the program converts the lensPixel angle from degrees to radians using the conversion factor assigned by DEGSinRAD: 57.29578 degs/rad.

Image Data generated dynamically from pixel grid is defined in Table 2.

After the initial values from Table 2 are entered into the processing unit 102, the processor 122 calculates the actual distances between the camera lens 104 and the lasers, 22, 28 and 34 in accordance with Table 3.

TABLE 2
Image Data generated dynamically from pixel grid

| Parameter | Meaning |
|---|---|
| DxA0Pᵢₙ | X pixel coordinate of the projected reference 26 |
| DyA0Pᵢₙ | Y pixel coordinate of the projected reference |
| | 26 |
| DxB0Pᵢₙ | X pixel coordinate of the projected reference 32 |
| DyB0Pᵢₙ | Y pixel coordinate of the projected reference 32 |
| DxC0Pᵢₙ | X pixel coordinate of the projected reference 38 |
| DyC0Pᵢₙ | Y pixel coordinate of the projected reference 38 |
| CamX | X pixel value of the image center pixel, |
| | typically ACAMxPIXELS/2 |
| CamY | Y pixel value of the image center pixel, |
| | typically ACAMyPIXELS/2 |
| PxLᵢₙ | X pixel location of object of interest's image |
| | upper left corner pixel |
| PxRᵢₙ | X pixel location of object of interest's image |
| | lower right corner pixel |
| PyLᵢₙ | Y pixel location of object of interest's image |
| | upper left corner pixel |
| PyRᵢₙ | Y pixel location of object of interest's image |
| | lower right corner pixel |

TABLE 3
actual distances between the camera lens 104 and the
lasers, 22, 28 and 34

| Parameter | Meaning | Formula |
|---|---|---|
| DCamLA | Physical | \sqrt{DCLXₐᵢₙ² + DCLY_{b}²} |
| | Distance(hypotenuse), from | |
| | the camera lens center to | |
| | Laser 22 | |
| DCamLB | Physical Distance | \sqrt{DCLX_{b}² + DCLY_{b}²} |
| | (hypotenuse) from the camera | |
| | lens center to Laser 28 | |
| DCamLC | Physical Distance | \sqrt{DCLXₐᵢₙ² + DCLYₐᵢₙ²} |
| | (hypotenuse) from the camera | |
| | lens center to Laser 34 | |

Next, the algorithm determines number of pixels in accordance with information in Table 4. This information is needed to calculate the angle between the camera lens image center 104 and projected references 26, 32 and 38.

TABLE 4
Angle calculation between the camera lens image
center 104 and projected references 26, 32 and 38

| Parameter | Meaning | Formula |
|---|---|---|
| LPAXpDC | X pixel distance between camera | DxA0Pᵢₙ − CamX |
| | lens image center pixel and | |
| | pixel representing reference 26 | |
| LPBXpDC | X pixel distance between camera | DxB0Pᵢₙ − CamX |
| | lens image center pixel and | |
| | pixel representing reference 32 | |
| LPCXpDC | X pixel distance between camera | DxC0Pᵢₙ − CamX |
| | lens image center pixel and | |
| | pixel representing reference 38 | |
| LPAYpDC | Y pixel distance between camera | DyA0Pᵢₙ − CamY |
| | lens image center pixel and | |
| | pixel representing reference 26 | |
| LPBYpDC | Y pixel distance between camera | DyB0Pᵢₙ − CamY |
| | lens image center pixel and | |
| | pixel representing reference 38 | |
| LPCYpDC | Y pixel distance between camera | DyC0Pᵢₙ − CamY |
| | lens image center and pixel | |
| | representing reference 38 | |

Next, the algorithm uses the length ACAMxPIXELS/2 and the angle ACamXin/2 to calculate the value CamHPseuxPix, which is the altitude of the larger triangle, and breaks it into two identical right triangles as shown in Table 5 and further in FIG. 12.

TABLE 5

| Parameter | Meaning |
|---|---|
| $\frac{ACAMxPIXELS}{2}$ | ½ of X pixel length of image, i.e. X pixel distance between center and edge |
| $\frac{ACamXin}{2}$ | ½ of the total lens/pixel angle |
| $tan ( \frac{ACamXin}{2} )$ | The tangent of the half-angle is equal to (ACAMxPIXELS/2)/CamHPseuXPix |

Then, the algorithm translates between 2-D pixel angle and 3-D physical (spatial) angle of the camera 102 in accordance with Table 6.

TABLE 6
Translation between 2-D pixel angle and 3-D physical
(spatial) angle of the camera 102

| Parameter | Meaning | Formula |
|---|---|---|
| CamHPseuxPix | Virtual pixel distance between the camera and the image center | $\frac{ACAMxPIXELS}{2 □ tan ( \frac{ACamXin}{2} )}$ |

The definition of the tangent that appears above is used to isolate CamHPseuxPix.

The algorithm continues with calculations of the following parameters in Table 7 and also shown in FIG. 13 looking at the image produced in XY plane of the wall 2 with X and Y representing the distances from the image center to the laser pixels seen and with LPAXpDC, etc., represent the X and Y distances.

These calculations allow to solve for the length of the segment between the camera lens center 104 and the projected reference on the wall 2. LPAHpDC, etc. is found using Pythagorean theorem with LPAHpDC as the hypotenuse. (This pixel length becomes one of the legs of the right triangle formed by the camera lens center and hypotenuse DHLAp. Knowing the values of both LPAHpDC and CamHPseuxPix allows to find the angle ACamLA using the definition of an arc tangent.

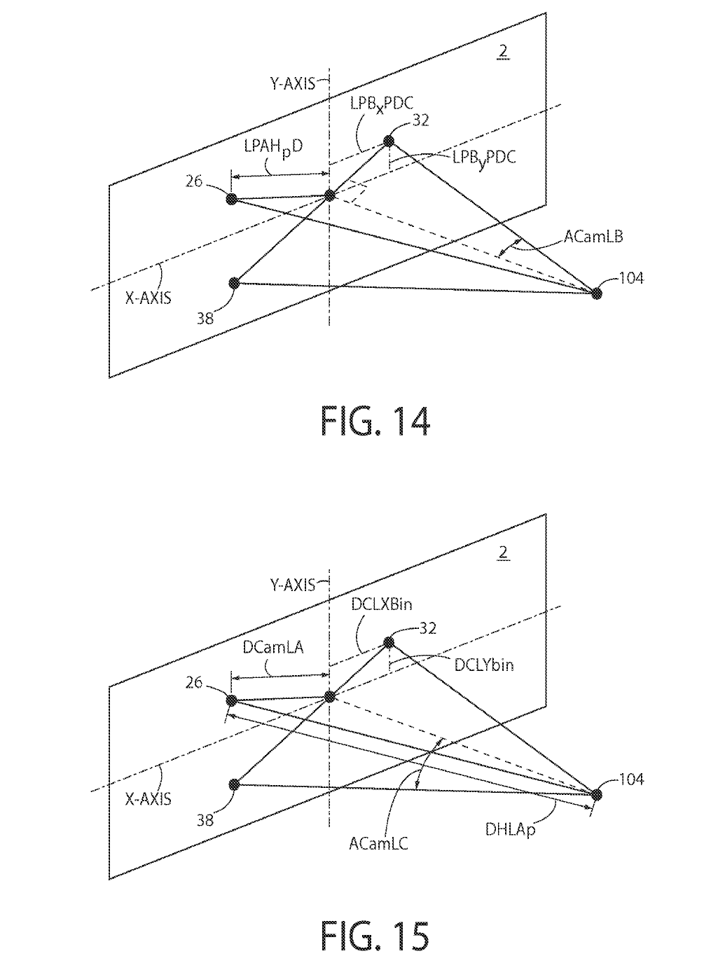

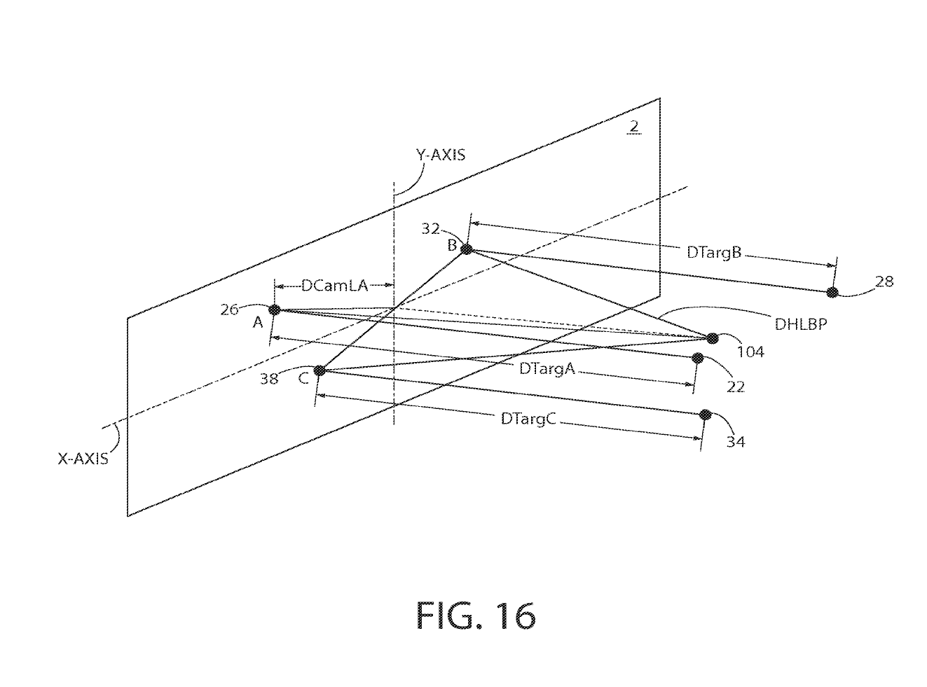

FIG. 14 illustrates the model to calculate hypotenuse physical 3d angle to the pixel laser point from the camera lens center 104. The 3-D hypotenuse length DHLAp between the camera lens center 104 and projected reference 26 is calculated as DcamLA/Sin(ACamLA). The same principles and relationships described herein apply to projected references 32 and 38 and their triangles.

Next, the algorithm includes a calculation of distances image plane of each laser to its reference projection on the wall 2 in accordance with Table 8. DTargX is found through employment of the Pythagorean theorem.

TABLE 7
Hypotenuse Calculations

| Parameter | Meaning | Formula |
|---|---|---|
| LPAHpDC | Pixel distance from image | \sqrt{LPAXpDC² + LPAYpDC²} |
| | center to projected | |
| | reference 26 | |
| LPBHpDC | Pixel distance from image | \sqrt{LPBXpDC² + LPBYpDC²} |
| | center to projected | |
| | reference 32 | |
| LPCHpDC | Pixel distance from image | \sqrt{LPCXpDC² + LPCYpDC²} |
| | center to projected | |
| | reference 38 | |
| ACamLA | Hypotenuse angle between the camera lens center 104 and the projected reference 26 of laser 22 on the wall 2 | ${tan}^{- 1} ( \frac{LPAHpDC}{CamHPseuxPix} )$ |
| ACamLB | Hypotenuse angle between the camera lens center 104 and the projected reference 32 of laser 28 on the wall 2 | ${tan}^{- 1} ( \frac{LPBHpDC}{CamHPseuxPix} )$ |
| ACamLC | Hypotenuse angle between the camera lens center 104 and the projected reference 38 of laser 34 on the wall 2 | ${tan}^{- 1} ( \frac{LPCHpDC}{CamHPseuxPix} )$ |
| DHLAp | Hypotenuse physical distance | DCamLA/Sin(ACamLA) |
| | from camera lens 104 to | |
| | projected reference 26 | |
| DHLBp | Hypotenuse physical distance | DCamLB/Sin(ACamLB) |
| | from camera lens 104 to | |
| | projected reference 32 | |
| DHLCp | Hypotenuse physical distance | DCamLC/Sin(ACamLC) |
| | from camera lens 104 to | |
| | projected reference 38 | |

TABLE 8
Physical distances between laser's image plane
and its projected reference.

| Parameter | Meaning | Formula |
|---|---|---|
| DTargA | Z-axis laser 22 physical | \sqrt{DHLAp² − DCamLA²} |
| | distance to target wall 2 | |
| DTargB | Z-axis laser 8 physical | \sqrt{DHLBp² − DCamLB²} |
| | distance to target wall 2 | |
| DTargC | Z-axis laser 34 physical | \sqrt{DHLCp² − DCamLC²} |
| | distance to target wall 2 | |

In the above example and calculations, projected references 26, 32 and 38 are positioned at the same x and y distances from the camera 102, for simplicity DCLYb same for 26 and 38 on y-axis, DCLXain same for 26 and 32 on X-axis). Thus,
Coordinate of the laser A intersection with the image plane located at (−DCLXain, DCLYb, DTargA)
Coordinate of the laser B intersection with the image plane located at (DCLXb, DCLYb, DTargB); and
Coordinate of the laser C intersection with the image plane located at (−DCLXain, −DCLYain, DTargC)

FIG. 15 illustrates how the physical laser distances are found from the physical camera (0,0,0), now that all the angles are known and DCamLA, DCamLB and DCamLC are known. The dashed line in the center is the camera lens center line representing the camera center pixel projected on the wall 2. The instant invention contemplates that the wall plane is not necessarily disposed parallel to the camera imager, and the right angles formed are not necessarily within the wall plane, as they could be above or behind it but still remain useful right angles. Also, the line segment of 26, 32 or 38 forming a right angle with the camera lens center line is not necessarily disposed in the wall plane.

FIG. 15 further illustrates physical distances of the lasers 22, 28 and 34 with their respective projected references.

Again, note that the coordinates made to this point represent the (x,y,z) relative to the camera (0,0,0) and its image plane, and not the wall plane (x,y) or wall plane (x,y,z) and its orientation and wall perspective. Camera pixel (x,y) has no simple correspondence to camera coordinates (x,y,z) or wall plane coordinates (x,y,z) (The use of a camera transform matrix is also contemplated to translate between the 3d points and the 2d points or visa-versa). The wall 2 and its points of interest (object corners, laser points, etc.) can be de-rotated using the camera's accelerometer, 3-axis magnetic compass or other basis, to obtain the normal wall orientation and object's orientation perpendicular to ground plane. De-rotation by converting the camera pitch and roll to an axis-and-angle frame of reference and simultaneously derotating using both angles in a quaternion is recommended. The yaw can be de-rotated later if desired. Also note de-rotation is not necessary to find the useful minimum distance of the camera to the wall or to find the distances between objects or objects features, as a simple Pythagorean theorem difference in 3d-space can be taken. Also, the ‘raw’ 3-D point locations relative to the camera can be directly placed in CAD software module and manipulated afterwards as needed to find any specific or specialized information as desired.

The dotted line represents the camera center lens pixel to the Wall plane and the DTargMid distance value

The calculations of the pixel representation of object of interest is performed in accordance with Table 9 and then subsequently calculate angles from each corner of object of interest to the camera lens center 104.

TABLE 9
Calculation of the pixel dimensions of the object 6
in the image and calculation of the angle from each corner to
the camera lens center.

| Parameter | Meaning | Formula |
|---|---|---|
| PXLinPDC | X-axis pixel distance from | PXLin − CamX |
| | object upper left to | |
| | camera center pixel | |
| PYLinPDC | Y-axis pixel distance from | PYLin − CamY |
| | object upper left to | |
| | camera center pixel | |
| PHLinPDC | Hypotenuse pixel distance | \sqrt{PXLinPDC² + PYLinPDC²} |
| | from object upper left to | |
| | camera center pixel | |
| PXRinPDC | X-axis pixel distance from | PXRin − CamX |
| | object lower right to | |
| | camera center | |
| PYRinPDC | Y-axis pixel distance from | PYRin − CamY |
| | object lower right to | |
| | camera center | |
| PHRinPDC | Hypotenuse pixel distance | \sqrt{PXRinPDC² + PYRinPDC²} |
| | from object lower right to | |
| | camera center | |
| APhL | Hypotenuse angle from object upper left to camera center | ${tan}^{- 1} ( \frac{PHLinPDC}{CamHPseuXPix} )$ |
| APhR | Hypotenuse angle from object lower to camera center | ${tan}^{- 1} ( \frac{PHRinPDC}{CamHPseuXPix} )$ |
| APxL | X-axis angle to object upper left | ${tan}^{- 1} ( \frac{PXLinPDC}{CamHPseuXPix} )$ |
| APyL | Y-axis degrees to object upper left | ${tan}^{- 1} ( \frac{PYLinPDC}{CamHPseuXPix} )$ |
| APxR | X-axis degrees to object lower right | ${tan}^{- 1} ( \frac{PXRinPDC}{CamHPseuXPix} )$ |
| APyR | Y-axis degrees to object lower right | ${tan}^{- 1} ( \frac{PYRinPDC}{CamHPseuXPix} )$ |

The algorithm next takes advantage of the plane which the lasers create to use for intersection with the ray/vector between the object featured on the wall plane through the pixel in the imager to the camera center/center pixel. We can use the equation of a plane with coefficients Q, R, S and T to describe the plane where Qx+Ry+Sz=T.

Q=p_{ay}□(p_{bz}−p_{cz})+p_{by}□(p_{cz}−p_{az})+□(p_{az}−p_{bz})

R=p_{az}□(p_{bx}−p_{cx})+p_{bz}□(p_{cx}−pₐₓ)+p_{cz}□(pₐₓ−p_{bx})

S=pₐₓ□(p_{by}−p_{cy})+p_{bx}□(p_{cy}−p_{ay})+p_{cx}□(p_{ay}−p_{by})

T=−(pₐₓ*(p_{by}*p_{cz}−p_{cy}*p_{bz}))−(p_{bx}*(p_{cy}*p_{az}−p_{ay}*p_{cz}))−(p_{cx}*(p_{ay}*p_{bz}−p_{by}*p_{az}))

(instead of ax+by+cz+d=0 we use qx+ry+sz+t=0 to avoid confusion with Lasers 22, 28 and 34)

We can rotate this plane's key or desired feature points using a variety of well known methods including Euler angles and rotation matrix, axis-and-angle, Quaternions and rotation matrix, etc.

If the camera image plane is reasonably parallel to the wall plane, and/or the camera is reasonably perpendicular or parallel to the ground plane, and/or the camera is parallel to the wall plane but rotated relative to the ground plane (not pointing straight up) then none or only one rotation in one plane is needed.

The sensor 160, such as accelerometer, continuously generates values in 3 axes as the handheld device being used and are defined in the algorithm in accordance with the Table 10.

TABLE 10
Accelerometer values separated
into X, Y and Z.

| Parameter | Meaning |
|---|---|
| AXACCELᵢₙ | Accelerometer X angle in degs |
| AYACCELᵢₙ | Accelerometer Y angle in degs |
| AZACCELᵢₙ | Accelerometer Z angle in degs |

Advantageously, the tilt angle measurements from the sensor 160 can be employed to account for any rotation of the camera 102 with respect to the XY plane surface of the wall 2, as shown in Table 10 along one axis (ie. About the X-axis only) as a simple example. It would be obvious to anyone skilled in the art to similarly rotate the resulting points on the plane around not just one but multiple axes' tilt angles as needed, if needed.

TABLE 11
1 axis Rotational calculations

| Parameter | Formula |
|---|---|
| P_{1xrotd} | P₁ₓ * cos(AxACCELin) − P_{1y} * sin(AxACCELin) |
| P_{1yrotd} | P₁ₓ sin(AxACCELin) + P_{1y} cos(AxACCELin) |
| P_{2xrotd} | P₂ₓ * cos(AxACCELin) − P_{2y} * sin(AxACCELin) |
| P_{2yrotd} | P₂ₓ sin(AxACCELin) + P_{2y} cos(AxACCELin) |
| P_{3xrotd} | P₃ₓ * cos(AxACCELin) − P_{3y} * sin(AxACCELin) |
| P_{3yrotd} | P₃ₓ sin(AxACCELin) + P_{3y} cos(AxACCELin) |

Optionally, knowing angles between wall plane and camera image plane allows us to rotate the camera 102 and derotate the wall 2 so that the Z dimension of the wall 2 plane equations allow the Z value to be constant for two opposite walls (ex. z=0 ft and z=10 ft) and the X dimension for the other two opposite walls are also constant (ex. x=0 ft and x=20 ft for a 10×20 ft room) (the Y-axis=0 being floor height and y being considered ceiling height in ft here). This is advantageous for more normally accepted CAD. Also, the CAD program can last be used to similarly rotate or transform the derived object coordinates along any axes as desired or needed, by for example, the tilt measurement angles. These plane angles are calculated in accordance with Table 11.

TABLE 11
Plane angle calculations

| Parameter | Meaning | Formula |
|---|---|---|
| DTargMid | Distance along the z-axis | T/S |
| | between the center of the | |
| | camera and the center of | |
| | the image along the lens | |
| | center line | |
| XPlaneAng | Angle of the camera image plane relative to the wall plane in X-axis | ${tan}^{- 1} ( \frac{T - Q}{S} - DT arg Mid )$ |
| ZPlaneAng | Angle of the camera image plane relative to the wall plane in Y-axis | ${tan}^{- 1} ( \frac{T - R}{S} - DT arg Mid )$ |

The plane equation is used to calculate the location of the Z on the wall plane at (0,0,z) and the distance between the camera at (0,0,0) and that point (0,0,z). Because T is equal to the sum of the three terms preceding it, it takes the place in the numerator. Because the only distance we travel is along the z-axis, we only need that distance and so take S, the coefficient of the z-term, as the denominator (Qx0+Rx0+SxDTargMid=T, DTargMid=T/s).

The above method has been demonstrated on the application of three light sources projecting references that are disposed at three corners of an orthogonal pattern at known distances between each other.

Alternatively, the method also applies to an embodiment using two projected references described above and the accelerometer 160 indicating orientation of the apparatus 10 relative to the ground plane, wherein the third reference is established as a pseudo-point reference. This is achieved by offsetting the point from a known projected reference on the wall (ex. (x,y+1) or (x,y−1) (non-collinear with the other two projected references) and calculating the new z-axis location of the pseudo-point reference based on the known camera angle differences (derived from the accelerometer) between the wall (perpendicular to the ground plane) and the camera's angles relative to the ground plane.

Creation of third reference from accelerometer 160 and two light sources is as follows.

Using a two light sources with both lasers on the top of the device and the camera 102 in the center and the device rotated forward towards the wall (top of device closer to wall) (ex. 45 degs) about the x axis only, (no rotation on the y axis in this example), obtain the two coordinates of the two real points on the surface.

Then, create the X coordinate for the third and new pseudo-reference located below the first real projected reference (Xa) as Xv, where Xv-Xa, hence both X axis locations are the same.

The Y axis location for the new pseudo-reference Yv is chosen to be an arbitrary distance down (Dd) from the real Xa point above it. Then, choose a value of 1 inch.

So,

Yv=Ya−Dd

The angle of the wall plane (Phi) is 90-theta, theta is the angle of tilt of the camera (forward) about the x axis.

So the new virtual points z axis location,

Zv=Za+Dd*tan(Phi)

This yields the coordinates of the third reference needed (Xv, Yv, Zv) which can then be plugged into the wall plane equation and subsequent steps to intersect the wall plane with rays of pixel locations of interest proceeds as usual.

A handheld portable apparatus having two or three light sources is configured to rollup or fold up can be advantageous in being very portable and compact when not in use, yet allowing a substantial distance separation between lasers for high distance accuracy.

Yet alternatively, using only one light source and accelerometer 160, the method is modified by projecting two references by rotating the camera 102 and using accelerometer 160 to indicate orientation of the apparatus 10 relative to the ground plane as well as using a 3-axis gyro or 3-axis magnetic compass to establish change in angles of the camera 102. Then, the third reference is established as the above described pseudo-point reference. The change in angles can be derived from the Smartphone's 3-axis magnetometer, integrated gyro measurements, and supplemental accelerometer measurements in the cases where the camera's pitch or roll has changed between pictures.

An example of using the Smartphone's accelerometer with a one laser or two laser embodiments to create/ensure an accurate or more accurate measurement is:

The Smartphone is held roughly parallel relative to the wall or surface 2 by the user. The software within the processor 122 reads the acceleration from the sensor 160 and is configured such that the Smartphone emits an audible signal indicating or annunciating when it is held substantially perpendicular to the ground plane, within an acceptable angular tolerance range depending on the desired accuracy of the application. The user continuously uses this audible signal to ensure that the Smartphone is held substantially perpendicular to the ground plane. The user sees horizontal grid lines or points on/overtop the image display on the screen 161 and uses the wall-to-ceiling line (WCL) 3 in the picture acquired by the camera 166 to orient the device by turning and adjusting its rotation about the Y axis until the WCL 3 is parallel or overtop the horizontal reference features on the display. At this point the device is most parallel to the wall and perpendicular to the ground. The laser is on and the distance to the wall is taken. The software then simply calculates the one or two other wall plane x,y,z virtual pseudo-point locations as (x+1,y,z) and (x, y+1,z), virtually offsetting other virtual lasers by 1 inch on the X axis and/or 1 inch on the y-axis (depending on if it is a one or two laser embodiment) enabling the creation of all 3 points needed for the wall plane equation and its coefficients. The features seen in the imager and other calculations are then extracted/chosen, measured and optionally used to generate CAD .dxf file output as described elsewhere herein.

The invention also contemplates the following

### EMBODIMENTS

using the evident angle change of a common visible point in both scenes as the device is abruptly rotated about the y-axis to sample 2 discrete pictures as a reference to calculate change in angles;

using the wall plane equation derived above, and a ray to a point of interest anywhere in the image from the camera lens center, and calculating the intersection of the ray with the wall plane, the (x,y,z) location of the point(s) of interest on the wall plane can be calculated;

using a camera transform matrix and related means to translate between the 3d real space of surface features (real, reference or artificial) and the 2d camera image pixel locations;

calculating the height of the objects from the floor if the floor-floor line is seen in the image, an object of known height is seen, or the camera height is known;

calculating the distance of the objects from the ceiling if the wall-ceiling line is seen in the image;

calculating distances between the wall edges and points of interest on the wall if the adjacent wall or wall-wall line intersection is seen in the image;

calculating areas and/or distances between the camera and wall plane features, or between features on the wall plane once all (x,y,z) locations are known;

calculating locations of all points of interest on the walls (including wall dimensions if the wall-wall or wall-ceiling lines are seen) if multiple pictures are taken but the camera is not moved, ie. only rotated about camera image plane center point around the y-axis (ie. in a plane parallel to the floor); and

generating a CAD file.

Wall features used for CAD dimensional input parameters may be automatically extracted from the image scene using known image processing techniques such as edge detection, line detection, straight line detection, etc. Alternatively or as an assist, the features seen in the pixels of the image may be manually discerned and designated. For example, the rectangle outlining a fuse box of interest may be manually drawn over the greyed pixels of its outer edge outline as seen in the image. This is far faster and/or conceptually easier than manually measuring and then entering the dimensions and location on the wall. Both methods may be simultaneously, ie, some features may be designated as unimportant manually and not be digitized. Other features may need to be added because the lighting was insufficient for the image processing algorithm, but discernable by human visual perception and manually added by drawing lines over desired features.

It should be noted that an algorithm to automatically or manually adjust the sub-pixel resolution location results can be achieved by the instant invention. This is done by providing a means to slightly move the sub pixel location of the reference points on the x and or y axis until an expected/calculated feature matches its visual counterpart. For example, if the imaged surface is far away and the reference points are close together, having little pixel separation, the artificial wall-ceiling line 3 (the line on the wall at the same constant y-axis height where the wall ‘ends’) may not match the real visual WCL 3 in the image. They may appear skewed or crossed. The pixels sub-pixel location may be adjusted by a few 1/10ths or 1/100ths up or down to make the calculated WCL 3 exactly overlay the visible image real WCL 3. This adjustment would also improve all the other features' location calculated accuracy.

Sub pixel resolution can be enhanced in this application by averaging the results of this method applied to multiple random samplings of almost perfectly focused laser points, example over a range/span of 4-8 on the x or y axis. In this way a means to greatly improve sub-pixel accuracy in this application can be achieved if such control over the camera hardware is available.

The instant invention further contemplates an enhanced accuracy method using visible features to fine tune the laser pixel's sub-pixel fractional positions.

The laser pixels' position, including their fractional position directly determine the wall plane equation and the locations of the objects/points/lines on the wall/features on the wall.

Known features with specific known properties such as the wall to ceiling line which is parallel to the ground plane—can be used as an added 2nd step input to the system to fine tune the accuracy significantly further. Since such features span a larger number of pixels than the laser points, they offer additional accuracy capability. By way of one example only, the 1st pass set of x, y coordinates for each laser point, optionally including sub-pixel res, are acquired. The resulting wall plane, camera loc and etc calculations are done.

The system can determine the location of a point on a wall, 3d . . . or determine where on the wall—a point in the picture will be 2d. So, 3d to 2d or 2d to 3d can be done using camera transform.

To enhance the resolution, a virtual point is placed on the WCL 3 (2d) by the user, visibly obvious to the user or an artificial intelligence (AI) programming. The 3d wall height location of this point is calculated and the computer calculated other 3d points on the wall the same height on the wall create a virtual expected calculated WCL 3 overtop the picture in 2d. Thus, only a second 3d point is needed.

Because a calculated line based on pixels typically a few hundred points separated (laser points) can sometimes be less accurate than the real line seen in the picture, the virtual line will appear skew to the real line. This is esp. true of the cheaper constructed camera models using lower resolution optics.

The user adjusting the laser pixel x, y coordinates s slightly (especially the y coordinates for the horizontal line) using a slider can improve the exact pixel position to exactly match the visible 2d ceiling line. Thus all features and calcs done will be as exact. All calculations are redone as the user adjusts the pixel locations slightly, causing a smooth adjusting of the visible WCL 3 artifact overtop the picture to match overtop the real line in the picture.

This method can be automated using AI to locate the WCL 3 and edge detection of the line to determine its second location. The trial and err solver converging on an exact match can be similarly be automated, or it can be done manually as an easily acquired skill.

Other line artifacts or features in the scene with known properties can be similarly used to adjust the accuracy. By way of another example, a large rectangle of known dimensions, for example a picture window, can be useful for such purpose.

The reader is also advised that three light source embodiment in a combination with a Smartphone does not require an accelerometer because the three points needed to create a plane are available. Thus, the distance from the Smartphone to the wall 2 and relative locations of projected references or other points of interest on the wall 2 calculated from the image is available for CAD. However, absent the WCL 3 or wall-floor line (WFL) 7, the orientation of the camera or objects in the scene relative to ground cannot be found. This may or may not be important depending on the user's needs.

In the three light source handheld unit solver properties, a WCL 3 or other horizontal reference line on wall is needed.

The three projected references are maintained parallel and their separation distances are known. Further, the U-joint maintains the three projected references generated in intersection with the plane in a perpendicular orientation with the ground level. The three light source line (3LL) intersects the WCL 3 (or extrapolated WCL 3 or horizontal reference line on plane) at a virtual point at a 90 degree angle. A second separate virtual line (2VL) is created from the desired object's point to the WCL 3, parallel to the 3LL and the 2VL is also at a ninety degree angle with the WCL 3. The angles from the camera lens center 104 to all features (real or virtual) in the scene are calculated from the image, including extrapolations or constructions of lines within the image. At least six interrelated tetrahedra are formed. The trigonometric relationships needed for the solver are established and using solver technology to solve the simultaneous nonlinear trigonometric relationships, (law of sines, law of cosines, law of sines of tetrahedron, et. All, etc.). Only one unique solution is converged upon to a maximal degree of accuracy, the same trigonometric equations are used as in the calculations in the four light source handheld unit. One of the results includes the x,y,z location of the desired feature points on the surface 2. The surface plane equation is derived from the real and virtual points and the locations of features on the surface are determined using the same methods disclosed herein for the other embodiments.

It must be noted that the advantages of the Smartphone embodiments with fewer lasers include greater hardware simplicity and hence less cost; decreased opportunity of obstructing one light source with a hand while taking a picture; and reduced power drain during usage.

Because the device allows for near exact re-placement and orientation of itself into a 3-D X, Y, Z location within a room after a picture taken (with distance to objects/walls and orientations with walls, objects on walls known), it allows for evident exact repositioning of the camera towards a scene. If any element in the scene is added/moved/removed/modified and the current scene is added to the negative of the old scene, everything but the changes will cancel out. Any items changed will immediately be evident (by software automatically or by a person manually) in the scene. Appropriate alarm/logging/notification output can then be generated.

The laser points and/or other features act as guides as the user or self automated device moves the camera until the exact spot of maximum subtraction occurs.

Because the laser point(s), accelerometer and/or compass orientation and derived readings are known, the above can easily be automated on a robot, quadcopter 350 mentioned elsewhere or other self-propelled object and the self contained device may automatically move from room to room or scene to scene within a room or warehouse and identify where/which objects have been added/moved/removed/modified.

Also, in an embodiment using known parallel-to-ground wall features, the perspective with one wall may be calculated and applied in an exactly opposite manner to the wall in the scene behind the camera (or visa-versa) even though no such features are evident on the wall behind the camera. Because it is usually assumed the walls are parallel and perpendicular to ceiling and ground and at right angles with each other, other dimensions can be easily derived. For example, if the wall-floor interface angle is seen by the front camera and the opposite wall ceiling interface angle is seen by the opposite camera, (ex. due to the camera tilting downward) and the angles and distances are known from the accelerometer and lasers, with only one picture taking event using both cameras the ceiling height and wall-to-wall distance as well as dimensions of other objects/features in the scene can be quickly derived. The objects of interest in a scene are not necessarily pre-known, and later objects can be chosen to be dimensioned and CAD type common .DXF files generated. Crosshairs pointing to the camera lens center in the image is useful to assist in designating an object of interest near that point to be measured, or spotting a distant laser point (s) from a parallel laser to find and verify they are hitting a sufficiently reflective area of the surface or not hitting a window or mirror.

Also useful is the laser infinity line on the image to assist spotting it or visually verifying it cannot hit anyone in the face/eyes or hit a reflective surface, especially when longer ranges and higher powered lasers are used.

Instant invention also contemplates that angled (nonparallel) lasers, which are crossed, are useful to increase accuracy, using more total pixels span for near and far distances. The advantages of crossed lasers include having more pixels to calculate distance, so more accuracy is attainable and a variety of possible crossing angles can be chosen/configured to accommodate any expected or existing distance situation, from very near to very far. The reader is advised that different target distances may require different angles for more useful results, that more hardware and software complexity may be needed to accommodate multiple different possible angles, that more calibration may be needed and/or more often because an out of calibration condition is less visually obvious (parallel lasers being non-parallel is obvious, non-parallel lasers being slightly off are unobvious), and that to avoid ambiguity, the lasers should be angled so that they would not exactly be inline in the same pixels line on the imager, but are skew.

A fixed laser pointing straight ahead and a second and/or third angled laser crossing under/over it can be useful in calculating the distance to distant objects using the single laser parallel to the lens center pixel ray, while also giving the advantages of greater accuracy from the crossed lasers.

Thus it is seen as valuable to have one laser roughly parallel to the camera lens center and a second laser crossing the first at various mechanically selectable angles depending on the needs of the situation, in this way there is no limitation on the distance of the object/wall to be measured.

It must be noted that preset angles adjustable laser may also make the unit function as a laser caliper—the distance where the fixed and adjustable laser are closest can be predetermined or post-measured or be used to position the camera/user or object(s) relative to camera a fixed distance away.

It is desirable to provide the ability to also rotate and/or stop at other pre-determined angles, depending on the scene and distance to the object and the wall, and the angle of the wall.

The angle of a crossed laser can exceed the camera angle however it is more often advantageous for the angle of a crossed laser to almost equal the camera angle so that a spot generated will be seen in the imager no matter how far away an object/wall at that point is, in this case also, the entire pixel width of the camera is used, and not just half the pixels as is the case with parallel lasers and the trace of all possible distances for a single parallel laser stopping at the infinity point, typically substantially in the middle of the screen.

It is not seen to be as useful to have angled lasers not cross but be less than the camera angle, this provides less than half (and possibly substantially less than half) of the pixels available for distance measurement as opposed to HALF the pixels as is in a parallel laser arrangement, or when a laser is parallel to the camera lens center. A crossed angled laser configuration is seen to be typically more accurate, distance, accuracy flexible and valuable than an uncrossed laser configuration.

It should be noted the features to be chosen for CAD generation can be automatically discerned using image processing techniques such as edge detection, constraint propagation, line detection for the wall-to-wall line (WWL) 5, WCL 3, corners of probable objects of interest (ex. windows) where horizontal or vertically detected lines meet, regions of darker or lighter coloration or varying hue are designated, etc. In this manner CAD files can be automatically generated, even on a real time basis shortly after the image is acquired. Further these CAD dimensions can then be displayed overlayed on top the acquired image to provide real time visually evident dimensions of elements in the scene.

Using three of the projected references found above in (x, y, z) space reflecting off the wall, a wall plane can be described and calculated in the form of ax+by+cz+d=0, which is a commonly known notation for a plane equation.

When the first device 20 and the second device 100 are disposed remotely from each other so that each can be rotated or moved independently and wherein the first device 20 is employed with the universal joint, the same method is used to find camera angles relative to projected references. However, the final results are obtained by an additional trial-and-error heuristic algorithm, operable to converge results to within desired accuracy or acceptable error margin.

The heuristic solver method takes advantage of at least one and preferably a plurality of known trigonometric equations such as law of sines of a triangle, law of cosines of a triangle, Pythagorean theorem, sum of angles, law of sines of tetrahedra. These equations are being solved for generally parallel with each other until a solution found to be sufficient when results from all equations converge to a within a predefined tolerance. This heuristic solver method can be practiced on the embodiment wherein the first device 20 includes three light sources disposed in line with each other and a known feature on the surface 2, for example such as a horizontal WCL 3 defining the perspective of the surface 2 or on an embodiment wherein the first device 20 includes four light sources disposed in an orthogonal pattern with known spacing between each light source and their projected references. In the embodiment employing three projected references, the heuristic solver method solves for multiple mathematically interrelated tetrahedra. In the embodiment employing four projected references, the heuristic solver method constructs a pyramid with the camera lens center 104 being an apex and all projected references forming a base.

Advantageously, the sensor 160 is not required with these two embodiments. More advantageously, the camera 102 can be independently positioned and oriented separately from the first device 20 and can be any existing camera, whose camera image angles are pre-known or later known at the time of final calculations. Also advantageously, the first device 20 can be independently positioned and oriented separately from the camera 102 and the surface (while being rotated about the Y-axis, being constrained by the Universal joint and gravity to maintain a perpendicular and parallel attitudes with the ground plane along both axes simultaneously). Finally advantageously, the first device 20 and the camera can be aimed at any separate locations on the surface, as long as all 4 points are seen in the camera image.

It has been found advantageous to align projected reference with a corner of the physical surface 2 and/or the object 6 so as to increase or maximize distance separation of resulting artificial reference pixels and hence accuracy of the final results, especially at large room scale or building scale distances. (If the camera is close to the object of interest to be measured, the lasers need only be separated enough to be seen in the image, preferably close to the edges to span the maximum number of pixels for greatest pixel resolution count accuracy.) The embodiments of the second device 100 positioned remotely and independently from the first device 20 facilitates increased spacing between each light source and allows to move projected references corner to physical corners. Or, when required, the spacing between the light sources can be decreased to a greater degree than presently allowed by mobile communication devices if the surface 2 and/or object 6 are smaller in size than the physical size of such mobile communication devices.

It should be noted a handheld unit including two light sources disposed in a vertical plane and connected to the Universal joint but rotated or rotateable horizontally to pseudo project a second pair of references parallel to the first pair on the surface 2, in an image combining the exposure of pre and post rotation references (4 points) should be considered the same embodiment as the image is identical to the four light source embodiment described above. This would be also equivalent to a two light source handheld unit with split beams coming out at an angle from the source. It would be understood that the angle of split must be appropriate for the distances to the surface, if the angle is too small the pixel separation accuracy at closer distances results in a lower than desired accuracy. If the angle is too large, the separate beams may not impinge on the surface 2 of interest located far away.

It should also be noted that the whole apparatus can be tiled upward or downward, such that the angle if tilt is known or the distance separation between the lasers is known. This condition simply changes the Y-axis separation input parameters and the solver calculations proceed as normal. This is advantageous when a building or feature above on a hill or below in a valley are to be dimensioned.

A conceptually simple method of using the two lasers handheld embodiment with separate accelerometer in camera is as follows.

Position the handheld first device 20 with two lasers to illuminate reference points near the objects of interest, from the side (ex. at a 45 degree angle with the surface but remaining perpendicular to ground). Next position a camera 102 with accelerometer (or on a U-joint such that the camera's desired axis is perpendicular to the ground) directly in front of the handheld unit's projected reference points. Use the accelerometer to indicate when the camera's desired axis is perpendicular to the ground. Observing the WCL 3 in the image, make the WCL 3 as horizontal as possible. The pixels for the two created reference points will create the X, Y locations for two points on the surface 2. Create a third virtual reference point a substantial distance away on the X axis, at the same height of the top laser of the hand held unit. The pixel distances between reference points can be used to linearly calculate the new X axis location of the new and third reference point. A tetrahedron is then created between the camera and the three reference points, the three camera angles to the reference points are known, the angles between the reference points on the surface easily calculated and the distances between the reference points calculable or known. All remaining elements (lengths and angles) of the tetrahedron can then be calculated. The distance to the surface (Z axis) is then known, the point's X,Y,Z locations are all calculable and the wall plane equation can be generated and the pixels on the object of interest can be used to precisely find the surface features of interest location for CAD purposes using the same methods described herein or other methods obvious to those of ordinary skill in the art.

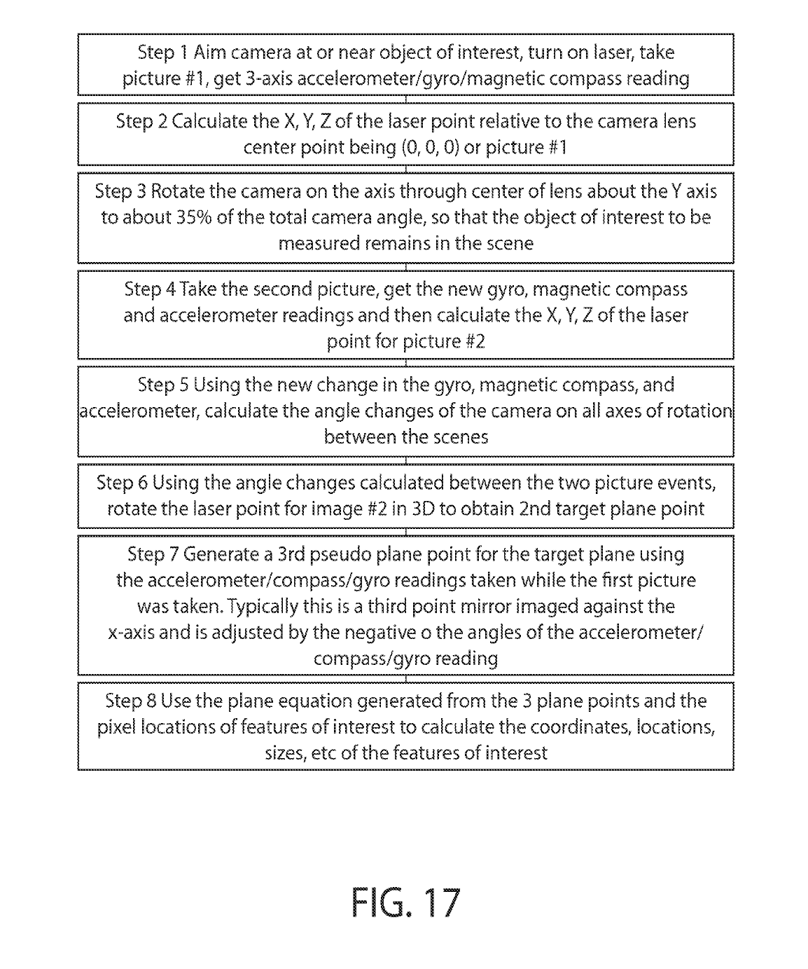

A conceptually simple method to use the single laser embodiment with accelerometer and without horizontal reference line in a picture to generate CAD suitable coordinates is shown in FIG. 17 and is as follows:

Turn on light source and perform triangulation of point location to get X, Y, Z coordinate of first projected reference relative to camera lens center 104. Next, rotate the camera 102 a substantial amount while maintaining light source on same plane in the region of object of interest, for example rotate it around the Y axis 20 degrees (roughly keeping it at the same height on the Y axis). The gyro or magnetic compass will then be used to measure the exact degree of rotation on the Y axis. Obtain the X,Y,Z location of that 2^{nd} new point. Next, rotate the camera around the X axis about the same amount, the accelerometer is best suited to measure this angle of displacement. Obtain the X, Y, Z location of that third new reference. Rotate the camera 102 back to its original desired position and using the three projected references just acquired, calculate the plane equation. Use the standard methods of ray intersecting plane from camera 102 or camera transform matrix to get the desired coordinates, sizes, shapes, etc of the objects of interest on the surface, etc, as disclosed elsewhere.

A single laser which is split into two or more beams using binary optics or beam splitters can be seen as a 2 or multiple laser embodiment. While providing some advantages over a single laser embodiment such as single step wall perspective capability using the second point, this is not as beneficial for as wide a variety of ranges as a two laser crossed embodiment, crossed (but still skewed enough to enable the lasers infinity line tracks to be discernably separate) at fifteen (15) feet, for example. The problem of measuring a narrow surface a distance away is worsened by such an arrangement, as is predicting where the beam will go in a room with people or windows to an outside street, the concern being hitting someone in the eye, albeit quite briefly.

In most embodiments, we often need to derotate the wall coordinates along the z-axis and x-axis using the Smartphone orientation based on its accelerometer angle readings indicating its attitude (pitch) and roll (bank) being acquired relative to the floor ground plane. We also need to derotate the orientation along the y-axis based on yaw calculated from the wall perspective obtained from the difference in laser distance readings across the wall on its X-axis. To do this we recommend converting the z-axis and x-axis to axis-and-angle rotation and derotating them back to 0 degrees. Then we recommend derotating the y-axis Yaw.

We recommend an iterative solver approach to solving the potentially oblique pyramid or tetrahedra created by the n-laser handheld units, either the four light balanced on U-joint, the three light source inline perpendicular to ground plane or the two light source inline perpendicular to ground plane with separate camera having accelerometer. Note that although a different set of interrelationships expressed in solving the simultaneous trigonometric equations will obviously be needed for each, the same set of commonly known trigonometric and geometric relationships disclosed herein are used.

Solving the balanced four light source embodiment (rectangle with top edge and bottom edge parallel to ground, side edges perpendicular to ground, all beams parallel) can use the tetrahedron law of sines, splitting the pyramid into two or four tetrahedra, and knowing the dimensions of the separation of the lasers on the y-axis, (but not the x) and the fact its a (preferably) rectangle parallel to the floor plane, and knowing all the angles at the apex of the pyramids/tetrahedra, sufficient information is available to arrive at a unique solution for the distances of the camera to the laser points on the wall plane and perspective of the wall plane with the camera, forming the wall plane location points and orientation with ground needed to then calculate the physical location of any other points on the wall plane based on their pixel location.

Also note that all handheld embodiments can be mechanically configured to tilt upward or downward at a measured angle, creating the equivalent of a device with a wider separation of parallel lasers intersecting the surface and creating the reference points. As long as this new separation value is known, example via the original distance and tilt angle, all calculations and results proceed as the same.

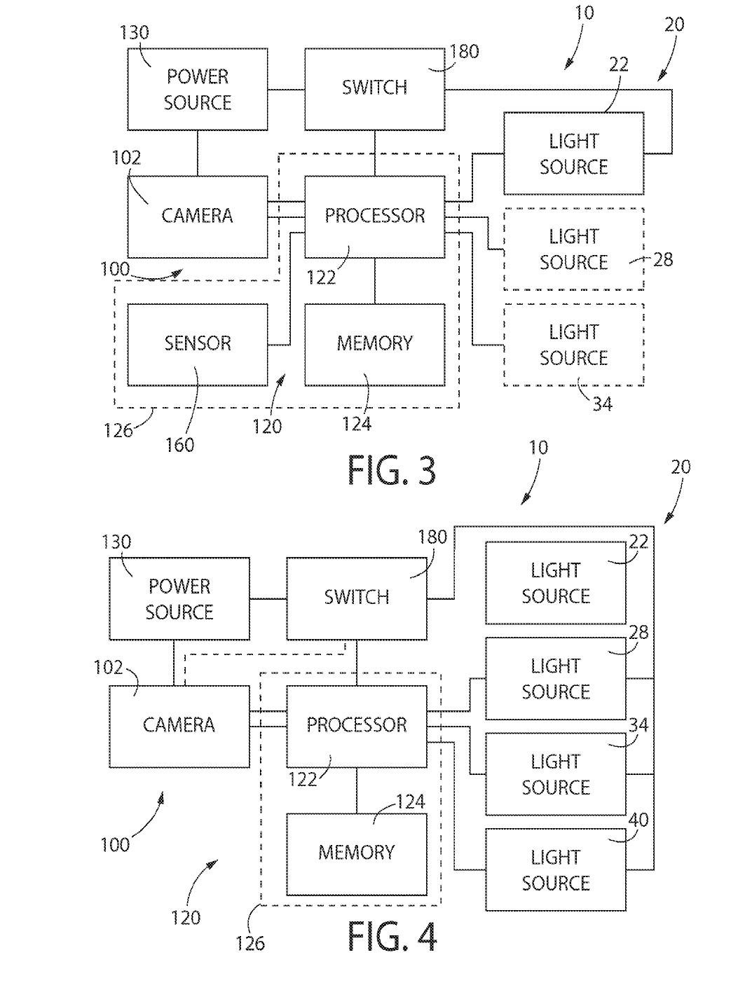

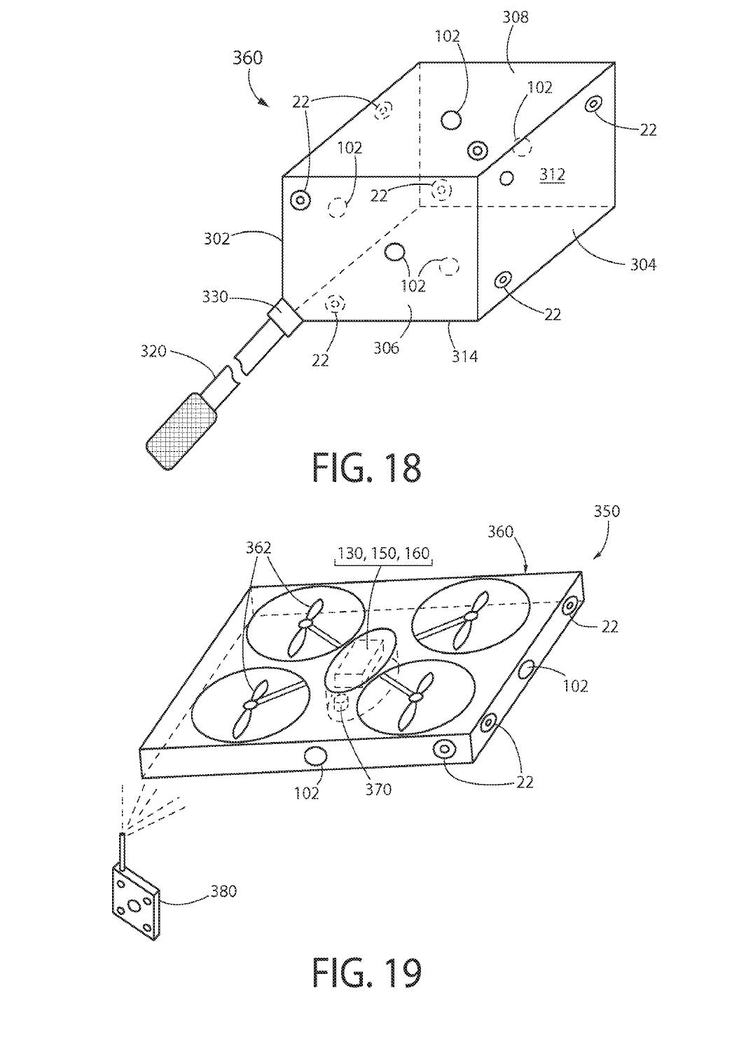

In accordance with another embodiment, shown in FIG. 18, therein is provided an apparatus, generally designated as 300, and comprising a member 302 having six orthogonally disposed sides 304, 306, 308, 310, 312 and 314. Two (or more) of light emitting devices 22 are disposed in or on one side, shown as the side 304, and are being spaced apart from each other in each of vertical and horizontal directions during use of the apparatus 300 and are configured to project two above described references 26 onto a first surface, for example being the above described surface 2. For the sake of brevity, all light emitting devices are referenced with numeral 22. A first camera 102 is disposed in or on the one side 304 and configured to capture an image of the two projected references 26 and is further configured to capture an image of at least a portion of the first surface and/or an object disposed thereon or therewithin. Additional five light emitting devices 22 are provided with each disposed in or on one of remaining sides and configured to project a reference onto a respective surface being disposed generally perpendicular or parallel to the first surface. Additional five cameras 102 are also provided, each disposed in or on the one of remaining sides and configured to capture an image of the projected reference and is further configured to capture an image of at least a portion of the respective surface and/or another object disposed thereon or therewithin. In further reference to FIG. 3, the sensor 160 is configured to detect tilt of at least one side in at least one plane. A power source 130 is also provided. A processing unit 120 is operatively configured to receive and process all images with no added movement or rotation needed so as to determine at least one of a distance to, orientation of, a shape of and a size of at least the portion of each surface and/or the object disposed thereon or therewithin and/or the dimensions of the room it is in regardless of the position and/or orientation of the device within the environment 1.

In accordance with yet another embodiment therein is provided an apparatus, generally designated as 300, comprising a member 302 having six orthogonally disposed sides; two or three light emitting devices 22 disposed in or on one side and spaced apart from each other in each of vertical and horizontal directions during use of the apparatus 300 and configured to project three references onto a first surface; a first camera 102 is disposed in or on the one side and configured to capture an image of the three projected references and is further configured to capture an image of at least a portion of the first surface 2 and/or an object or objects 6 disposed thereon or therewithin; there are five additional light emitting devices 22, each disposed in or on one of remaining sides and configured to project a reference onto a respective surface being disposed generally perpendicular or parallel to the first surface 2; five additional cameras 102, each disposed in or on the one of remaining sides and configured to capture an image of the projected reference and is further configured to capture an image of at least a portion of the respective surface and/or another object disposed thereon or therewithin; a handle 320 has one end thereof attached to the member 302 and the processing unit 120 is operatively configured to receive and process all images with no added movement or rotation needed so as determine at least one of a distance to, orientation of, a shape of and a size of at least the portion of each surface and/or the object disposed thereon or therewithin and/or the dimensions of the room it is in regardless of the position and/or orientation of the apparatus 300 within the room. The apparatus 300 further includes a three-axis accelerometer 160 or a U-joint 330 coupled between the member and the handle 20 which also allows to use only a pair of light emitting devices on the one side.

In accordance with a further embodiment of FIG. 19, therein is provided an apparatus, generally designated as 350, essentially constructed on a principles of a flying device 350, for example such as a quadcopter, wherein it is also contemplated that any existing quadcopter are retrofitable in the field with the above described features of the invention; a pair of light emitting devices 22 are configured to project two references onto a first surface; a first camera 102 is configured to capture an image of the two projected references and is further configured to capture an image of at least a portion of the first surface and/or an object disposed thereon or therewithin; additional five light emitting devices 22 are provided (only one of which is shown in FIG. 18 for the sake of clarity), each disposed on each of remaining three edge surfaces and the top and bottom surfaces and configured to project a reference onto a respective surface being disposed generally perpendicular or parallel to the first surface; additional five cameras 102 (only one of which is shown in FIG. 18 for the sake of clarity), each disposed on the each of the remaining three edge surfaces and the top and bottom surfaces, the each camera further configured to capture an image of the respective projected reference and is further configured to capture an image of at least a portion of the respective surface and/or another object disposed thereon or therewithin; there are a power source 130 and a processing unit 120 operatively configured to receive and process all images so as determine at least one of a distance to, orientation of, a shape of and a size of at least the portion of each of six surfaces and/or the objects disposed thereon or therewithin. A conventional remote control unit 380 is employed for controlling not only the flying path of the quadcopter 350, but also incorporates at least a portion and even the entire processing unit 120 for control of the light sources 22 and cameras 102 through the radio frequency (RF) communication.

Advantageously, quadcopter 350, incorporating integral three-axis accelerometer and three-axis gyro, is configured to maintain planar relationship parallel to the ground plane during all aspects of the flight, thus requiring only two light emitting devices on one, generally a front edge surface, due to the inherent planarity, and when using simplified mathematical algorithms.

The quadcopter 350 can thus instantly calculate its exact location within the environment 1, for example such as a room or hallway (constituting an accurate Local Positioning System), and use this calculation to autonomously navigate to waypoints within a room, hallway or building as needed. Further, the quadcopter 350 can instantly calculate its exact orientation within the room, enabling it to exactly recreate its position and orientation at a later date or time. Coupled with an earlier snapshot saved for comparison purposes of that same location and orientation, and with a simple image subtraction algorithm, the quadcopter 350 can automatically immediately ascertain and optionally alarm whether any objects in the captured images have been moved or removed since the previous picture was taken, on a real time basis. Further still, the quadcopter 350 can use the dimensions calculated and fed into a CAD program to project the dimensions (using laser image projector) of imagined or virtual structures known or predicted to be on or directly behind the surfaces such as conduit, wiring, piping, air ducts, measurements, rulers, where to cut, and building beam or stud locations on a real time basis, stationary or even as the quadcopter 350 moves. A bidirectional radio frequency (RF) link to a remote processing unit (CPU) may certainly be needed to provide sufficient CPU power to accomplish such tasks more quickly. Similarly, the same link may be used for continuous or occasional communication with a human decision maker when a critical juncture decision point arises.

This can be used for automatic guidance in emergency situations, such as guiding firefighters needing to break thru a wall. Also, the device when equipped with additional environmental sensors (such as smoke, CO2, CO, O2, O3, H2S, methane or other gas detectors, infrared cameras, passive infrared (PIR) motion sensors, radiation detectors, low frequency vibration or sound detectors, light, temperature or humidity detectors,) can be used to less expensively automatically monitor multiple areas in large industrial environments for developing conditions where equipment is overheating, motor bearings are requiring grease, hazardous accidents have occurred, wildlife or rodent infestations are indicated, motors are out of balance and vibrating excessively, motors are not running due to a lack of expected noise levels, lights have burnt out, life threatening areas have been created, accidents or spills have occurred, etc. This can also go into accident sites and search for survivors or injured, or guide survivors thru hazardous areas or around hazardous areas by autonomously choosing different routes of escape using its sensed anomaly highly accurate local positioning system (LPS) locations, current sensor readings, inherent map of its environment (pre-loaded or ascertained by wandering) and/or simple Artificial intelligence (AI) techniques. This method can be considerably less expensive than installing multiple sensors throughout an industrial facility at multiple locations requiring monitoring.

Furthermore, the quadcopter 350 can successfully navigate and/or acquire dimensions with only light source 22, using the WCL 3 as a reference to determine the quadcopter 350's orientation with the wall 2 in front of it and hence to its sides. The exact orientation can be calculated based on the image of the wall-ceiling line acquired. Alternatively, a simple Proportional Integral Derivative (PID) control loop based correction algorithm can be used to maintain a constant quadcopter 350 orientation with the wall 2 in front and hence walls to its side. The degree of nonalignment of the quadcopter 350 based on the slope of the WCL 3 seen in the image can be input into a PID self-auto-correcting loop. As is typical in a PID loop, the WCL's slope is used as a process variable which is used to generate a control signal which is sent to the controls of the quadcopter 350 and causes the quadcopter 350 to turn about its axis to correct its out of alignment orientation with the visible forward facing wall. This continuous feedback loop, when whose P, I, and D parameters are properly tuned, will quickly cause a turn to the correct alignment and maintain it going in the desired direction. Images acquired for processing can further benefit from a parallel alignment with the wall in front of it, maintaining a parallel wall perspective and making the calculations and flight path straightforward and simpler.

Again, the necessary edge detection and image processing can be done on a remote CPU as desired if the images are conveyed over a bi directional RFlink to it and the resulting control signals are fed back to the quadcopter 350.

Further, a WWL 5 in the image can be used to calculate the quadcopter 350's distance to that wall. Hence, in a typical hallway or room and with an appropriately angled lens yielding a camera X-axis angle of about 60 degrees (which is typical for a Smartphone camera), the device can approach to about ten (10) foot of a room or hallway with a ten (10) foot wall to wall separation, while maintaining image contact with the WCL 3 and/or wall-wall-corners using the same single forward camera about five (5) foot on either side on the quadcopter 350. Because the quadcopter 350 maintains its parallel orientation with the ground, the laser point can be imaged to get significantly close to the ceiling, hence maintaining a flying height of about one (1) foot below the ceiling is easily achieved in typical size rooms or hallways.

The instant invention also contemplates use of a global positioning system (GPS) devices 370 mounted within the qudracopter 350 so as to improve, in combination with LPS, an accuracy of determining absolute location of such qudracopter in the environment of interest.

Furthermore, the qudracopter 350 can be configured with a single light source 22, rather than two light sources when WCL is visible at all times and is processed to obtain orientation information.

Instant invention has many advantages: enabling capture of the environment and its dimensions in time it takes to take a picture: resulting in faster generation of CAD models; rulerless non-contact measurement; better accuracy than TOF method in close ranges; ease of use by a novice user; inexpensive to manufacture; offers extended range of capabilities, especially with employment of upgrade techniques. All features of the environment can be stored for later use.

Markets for the above embodiments includes construction, real estate, medical/biometrics, insurance claims, contractor/interior decorator, navigation indoors, CAD applications, emergency response, security and safety.

The invention can be used with different hardware platforms and various software platforms.

Advantageously, the accuracy of the above described apparatus (based on fixed, pre-chosen laser angles) changes with distance to target surface. The greatest accuracy occurs when the apparatus is closest to the surface 2 to be measured without losing the reference points beyond the edges of the pixel plane.

Combining one or more TOF laser distance measure devices visible in the imager in place of the standard lasers used as reference generators enables greater accuracy at long range distances while also getting the benefits of the greater short range accuracy of the triangulation based plane determining distance measuring device herein.

The calculations are slightly different as the TOF device directly gives the distance to the reference point, and it need not be calculated based on the pixel location and triangulation. The angle of the TOF laser with the image plane and the virtual X,Y location of the TOF laser relative to the image plane remains needed. As an example, if in a two light source embodiment, one of the lasers is TOF, the pixel distance separation and other calculations may indicate a distance to target plane of 30 ft with an accuracy of 3 inches. The TOF based laser technique could enable calculating the distance to target plane to an accuracy of 0.125″ and that higher accuracy can be used to better size the objects or the wall perspective accuracy.

It has been found that with a reference point image being positioned at about 24 inches away, a camera angle of about 60 degrees and a horizontal pixel resolution of 2400 points or 100 points per inch, the four light source embodiment can easily achieve accuracy of measurements to about 0.01 inches, excluding sub-pixel resolution enhancements. This is far beyond the capability of commonly used TOF devices today.

At intermediate distances, where the accuracy of the TOF lasers is roughly the same as the accuracy of the triangulation method, the TOF laser distance measurement can be averaged with the results of the above described method to generally give a more accurate resulting distance measurement which is then incorporated into the plane equation calculation.

It has been also found that embodiments employing either two or three light sources disposed in line with each other offer an economical solution with an independent camera 2.

While the present description is directed toward a handheld device, enhanced Smartphone or similar portable device, remotely controlled flying devices, those skilled in the art will appreciate that the present invention could be incorporated into other devices, systems and methods. For example, vehicles, aircraft, watercraft, land vehicles, missiles, cameras, surveillance devices, manufacturing systems, and the like could benefit from the present invention.

Thus, the present invention has been described in such full, clear, concise and exact terms as to enable any person skilled in the art to which it pertains to make and use the same. It will be understood that variations, modifications, equivalents and substitutions for components of the specifically described embodiments of the invention may be made by those skilled in the art without departing from the spirit and scope of the invention as set forth in the appended claims.

I claim:

1. An apparatus comprising:
a first device configured to project one or more references onto a surface;
a second device configured to capture an image of said one or more projected references and is further configured to capture an image of at least a portion of said surface and/or an object disposed thereon or therewithin; and
a processing unit operatively coupled to at least one of said first and second devices and configured to receive and process all images so as to determine an information about said at least portion of said surface and/or said object or objects disposed at least one of on, within and adjacent the surface.

2. The apparatus of claim 1, wherein said information includes at least one of a distance to, orientation of, a shape of and a size of.

3. The apparatus of claim 1, further comprising a mobile communication device, wherein said first device is directly attached to or being integral with a housing of said mobile communication device, wherein said processing unit is integrated into a processing unit of said mobile communication device and wherein said second device is a camera provided within said mobile communication device, said camera having a lens.

4. The apparatus of claim 1, further comprising a mounting member and a source of power, wherein said first device and said processing unit are attached to said mounting member and are operatively coupled to said source of power.

5. The apparatus of claim 4, wherein said second device is further attached to said mounting member and is operatively coupled to said source of power.

6. The apparatus of claim 4, further comprising a handle member and a joint movably connecting said mounting member to one end of said handle member, said joint is configured to at least align an axis of said first device with a horizontal orthogonal axis during use of said apparatus.

7. The apparatus of claim 4, wherein said second device is disposed external to and remotely from said mounting member during use of said apparatus.

8. The apparatus of claim 1, further comprising a mounting member being configured to be releaseably connected to an exterior of a mobile communication device, wherein said first device is attached to said mounting member and wherein said second device and said processing unit are integrated into said mobile communication device.

9. The apparatus of claim 8, wherein said first device is coupled to a power source and a control signal of said mobile communication device.

10. The apparatus of claim 8, further including a source of power attached to said mounting member and a switch electrically coupled between said source of power and said first device, said switch is manually operable to selectively connect power to and remove said power from said first device.

11. The apparatus of claim 1, wherein said first device includes a single light source operable to emit a beam of light defining said one reference and is further operable by, a rotation, to project two or more successive references and wherein said first device further includes a sensor configured to measure an angular displacement of an axis of said single light source and/or an axis of said second device from one or more orthogonal axis.

12. The apparatus of claim 11, wherein said sensor is one of an inclinometer, an accelerometer, a magnetic compass, and a gyroscope.

13. The apparatus of claim 1, wherein said first device includes a single light source operable to emit a beam of light defining said one reference, wherein said first device further includes a sensor configured to measure an angular displacement of an axis of said beam of light and/or an axis of said second device from one or more orthogonal axis and wherein said second device is operable to capture an image of a horizontal reference line.

14. The apparatus of claim 13, wherein said light source is one of a laser and a light emitting diode (LED).

15. The apparatus of claim 1, wherein said first device includes two or three light sources spaced apart from each other in at least one of vertical and horizontal directions during use of said apparatus, each operable to emit a beam of light and wherein said first device further includes a sensor configured to measure an angular displacement of an axis of said second device from one or more orthogonal axis.

16. The apparatus of claim 1, wherein said first device includes four light sources, each disposed at a corner of an orthogonal pattern and operable to emit a beam of light.

17. The apparatus of claim 16, wherein axes of said four light sources are disposed in a parallel relationship with each other and wherein said first device projects four references disposed in an orthogonal pattern on the surface.

18. The apparatus of claim 1, wherein said processing unit includes a processor, said processor configured to triangulate angular relationships between an axis of said second device and each of said two or more projected references in accordance with a predetermined logic.

19. The apparatus of claim 1, wherein said processing unit includes a processor, wherein said first device includes one or more light emitting devices and wherein said processor is configured to determine said information in absence of a time-of-flight light interrogation techniques.

20. The apparatus of claim 1, wherein said apparatus is configured as a handheld apparatus and is further configured to determine said information without a continuous rotation about any one of three orthogonal axes.

21. The apparatus of claim 1, further comprising a mounting member defining orthogonally disposed edge surfaces and a pair of top and bottom surfaces, said apparatus configured to fly in a plane generally parallel to a ground plane and including at least one of a three-axis accelerometer, a three-axis gyro and a processing unit, wherein said first device includes:
a pair of light emitting devices spaced apart from each other in each of vertical and horizontal directions during use of said apparatus and configured to project two references onto a first surface, and
additional five light emitting devices each disposed on each of remaining three edge surfaces and said top and bottom surfaces and configured to project a reference onto a respective surface being disposed generally perpendicular or parallel to the first surface;
and wherein said second device includes a camera configured to capture an image of said two projected references and is further configured to capture an image of at least a portion of the first surface and/or an object disposed thereon or therewithin, and
additional five cameras each disposed on said each of said remaining three edge surfaces and said top and bottom surfaces, said each camera further configured to capture an image of said respective projected reference and is further configured to capture an image of at least a portion of the respective surface and/or another object disposed thereon or therewithin.

22. The apparatus of claim 21, wherein said member is configured for flying in a plane being parallel to a ground plane.

23. A method comprising the steps of:
(a) projecting, with a first device, one or more reference images onto a surface;
(b) capturing, with a second device, said one or more reference images and an image of at least a portion of said surface;
(c) receiving, at a processing unit, image data from said second device, said image data containing pixel representation of said one or more reference images in a relationship to said at least portion of said surface and/or an object or objects disposed thereon or therewithin;
(d) calculating, with said processing unit based on said image data and a first logic algorithm, angular relationships between said second device and each of said one or more projected references; and
(e) determining, with said processing unit based on said calculated angular relationships and a second logic algorithm, an information about said at least portion of said surface and/or said object or objects.

24. An apparatus comprising:
a member having six sides, each disposed in a unique plane;
a pair of light emitting devices disposed in or on one side and spaced apart from each other in each of vertical and horizontal directions during use of said apparatus and configured to project two references onto a first surface;
a first camera disposed in or on said one side and configured to capture an image of said two projected references and is further configured to capture an image of at least a portion of the first surface and/or an object disposed thereon or therewithin;
additional five light emitting devices, each disposed in or on one of remaining sides and configured to project a reference onto a respective surface being disposed generally perpendicular or parallel to the first surface;
additional five cameras, each disposed in or on said one of remaining sides and configured to capture an image of said projected reference and is further configured to capture an image of at least a portion of the respective surface and/or another object disposed thereon or therewithin;
a sensor configured to detect tilt of at least one side in at least one plane; and
a processing unit operatively configured to receive and process all images so as to determine an information about at least the portion of each surface and/or the object disposed thereon or therewithin.

25. An apparatus comprising:
a member having six sides, each disposed in a unique plane;
at least two light emitting devices disposed in or on one side and spaced apart from each other in each of vertical and horizontal directions during use of said apparatus and configured to project three references onto a first surface;
a first camera disposed in or on said one side and configured to capture an image of said three projected references and is further configured to capture an image of at least a portion of the first surface and/or an object disposed thereon or therewithin;
additional five light emitting devices, each disposed in or on one of remaining sides and configured to project a reference onto a respective surface being disposed generally perpendicular or parallel to the first surface;
additional five cameras, each disposed in or on said one of remaining sides and configured to capture an image of said projected reference and is further configured to capture an image of at least a portion of the respective surface and/or another object disposed thereon or therewithin; and
a processing unit operatively configured to receive and process all images so as determine an information about at least the portion of each surface and/or the object disposed thereon or therewithin.

26. An apparatus comprising:
a flying device;
a pair of light emitting devices spaced apart from each other in each of vertical and horizontal directions during use of said apparatus and configured to project two references onto a first surface;
a first camera configured to capture an image of said two projected references and is further configured to capture an image of at least a portion of the first surface and/or an object disposed thereon or therewithin;
additional five light emitting devices each disposed on each of remaining three edge surfaces and said top and bottom surfaces and configured to project a reference onto a respective surface being disposed generally perpendicular or parallel to the first surface;
additional five cameras each disposed on said each of said remaining three edge surfaces and said top and bottom surfaces, said each camera further configured to capture an image of said respective projected reference and is further configured to capture an image of at least a portion of the respective surface and/or another object disposed thereon or therewithin; and
a processing unit operatively configured to receive and process all images so as to determine an information about at least the portion of each of six surfaces and/or the objects disposed thereon or therewithin.
